(19) United States
(12) Patent Application Publication
(10) Pub. No.: US 2015/0180544 A1
(43) Pub. Date: Jun. 25, 2015

(54) INFORMATION PROCESSING TERMINAL APPARATUS CONNECTED TO OPPOSED CONNECTION DEVICE VIA PROXIMITY WIRELESS COMMUNICATION

(71) Applicant: Panasonic Corporation, Osaka (JP)

(72) Inventors: Takashi Morimoto, Osaka (JP); Takeshi Nakayama, Hyogo (JP); Masahiro Ishii, Hyogo (JP); Kouji Kai, Fukuoka (JP)

(21) Appl. No.: 14/241,117

(22) PCT Filed: Sep. 4, 2013
(86) PCT No.: PCT/JP2013/005245

§ 371 Date: Feb. 26, 2014

(30) Foreign Application Priority Data
Oct. 11, 2012 (JP) 2012-226132

(51) Int. Cl. H04B 5/00; G06F 3/0484

(52) U.S. Cl. CPC H04B 5/0031; G06F 3/0484

(57) ABSTRACT

An information processing terminal apparatus is provided with antennas formed of a transparent conductive film on a front surface of a liquid crystal panel. The information processing terminal apparatus selects data transfer antennas from the antennas, and performs a proximity wireless communication between a transmission antenna of the recording media and the data transfer antenna and between an receiving antenna of the recording media and the data transfer antenna when the transmission antenna and the receiving antenna of the recording media are opposed to the data transfer antennas, respectively.

### TECHNICAL FIELD

The present disclosure relates to an information processing terminal apparatus such as a tablet terminal, a connection equipment wirelessly connected to the information processing terminal apparatus, a communication system provided with the information processing terminal apparatus and the connection equipment, and a communication method for the communication system.

### BACKGROUND

In recent years, a portable information processing terminal apparatus represented by a tablet terminal and a smartphone has been widely used. In Patent Literature 1 and Patent Literature 2, there is a description of terminal apparatuses provided with touch panels according to conventional technologies.

### CITATION LIST

### Patent Literature

PATENT LITERATURE 1: Japanese Patent Laid-open Publication No. JP2012-64123 A
PATENT LITERATURE 2: Japanese Patent Laid-open Publication No. JP2003-346094 A

### SUMMARY OF THE INVENTION

### Technical Problem

Users of a portable information terminal apparatus have strongly required miniaturizing and thinning the information processing terminal apparatus, and improving the waterproof property and the designability of the information processing terminal apparatus. Extremely speaking, the information processing terminal apparatus for realizing these demands may have at least only a display in appearance. In existing portable information processing terminal apparatuses, for example, a button for performing the key input operation is implemented on the display as a touch panel. However, the existing portable information processing terminal apparatuses are provided with connection terminals such as power supply terminals and USB (Universal Serial Bus) connector terminals. Accordingly, the above demands of the user are not completely responded to.

An object of the present disclosure is to solve the above-described problems, and to provide an information processing terminal apparatus smaller and thinner than that of the prior art, and realizing the waterproof property and the designability higher than that of the prior art, a connection equipment wirelessly connected to the information processing terminal apparatus, a communication system provided with the information processing terminal apparatus and the connection equipment, and a communication method for the communication system.

### Solution to Problem

According to an information processing terminal apparatus of one aspect of the present disclosure, the information processing terminal apparatus performs a proximity wireless communication with a connection equipment comprising a first antenna. The information processing terminal apparatus includes displaying means configured to display predetermined information, at least one second antenna formed of a transparent conductive film on a front surface of the displaying means, and control means configured to select a data transfer antenna from the at least one second antenna, and perform the proximity wireless communication between the first antenna and the data transfer antenna when the first antenna is opposed to the data transfer antenna.

In addition, according to a connection equipment of one aspect of the present disclosure, the connection equipment performs a proximity wireless communication with an information processing terminal apparatus. The connection equipment includes a first antenna. The information processing terminal apparatus includes displaying means for displaying predetermined information, at least one second antenna formed of a transparent conductive film on a front surface of the displaying means, and control means for selecting a data transfer antenna from the at least one second antenna, and performing the proximity wireless communication between the first antenna and the data transfer antenna when the first antenna is opposed to the data transfer antenna.

Further, according to a communication method of one aspect of the present disclosure, the communication method for a communication system includes an information processing terminal apparatus and a connection equipment configured to perform a proximity wireless communication with the information processing terminal apparatus. The connection equipment includes a first antenna, and the information processing terminal apparatus includes displaying means configured to display predetermined information and at least one second antenna formed of a transparent conductive film on a front surface of the displaying means. The communication method includes the step of selecting a data transfer antenna from the at least one second antenna, and performing the proximity wireless communication between the first antenna and the data transfer antenna when the first antenna is opposed to the data transfer antenna, by the information processing terminal apparatus.

### Advantageous Effects of the Invention

According to the above configurations, the information processing terminal apparatus includes at least one the second antennas formed of the transparent conductive film on the front surface of the display means, selects the data transfer antenna from at least one the second antennas, and performs the proximity wireless communication between the first antenna and the data transfer antenna when the first antenna of the connection equipment is opposed to the data transfer antenna. Accordingly, it is possible to provide the information processing terminal apparatus smaller and thinner than that of the prior art, and realizing the waterproof property and the designability higher than that of the prior art, the connection equipment wirelessly connected to the information processing terminal apparatus, the communication system provided with the information processing terminal apparatus and the connection equipment, and the communication method for the communication system.

### BRIEF DESCRIPTION OF DRAWINGS

FIG. 1 is a plan diagram showing a configuration of a communication system provided with an information processing terminal apparatus 1 and a recording media 2 according to a first embodiment of the present disclosure.

FIG. 2 is a block diagram showing configurations of the information processing terminal apparatus 1 and the recording media 2 of FIG. 1.

FIG. 3 is a partially cross sectional view cutting across an antenna R1 of the information processing terminal apparatus 1 of FIG. 1.

FIG. 4 is a top diagram showing a position of the recording media 2 when it is possible to perform the proximity wireless communication between the information processing terminal apparatus 1 and the recording media 2 of FIG. 1.

FIG. 5 is a top diagram showing a position of the recording media 2 when it is possible to perform the proximity wireless communication between the information processing terminal apparatus 1 and the recording media 2 of FIG. 1.

FIG. 6 is a timing chart showing operation of the communication system of FIG. 1.

FIG. 7 is a plan diagram showing a cross mark 51 and a text message 52 displayed on a liquid crystal panel 31, in step S11 of FIG. 6.

FIG. 8 is a plan diagram showing a mark 53 and a text message 54 displayed on the liquid crystal panel 31, in step S15 of FIG. 6.

FIG. 9 is a plan diagram showing a text message 55 displayed on the liquid crystal panel 31 and the recording media 2, in step S17 of FIG. 6.

FIG. 10 is a format diagram showing a format of a device information signal S2 of FIG. 6.

FIG. 11 is a timing chart showing a communication state when the device information signal S2 of FIG. 6 is repeatedly transmitted from the recording media 2 to the information processing terminal apparatus 1 of FIG. 1.

FIG. 12 is a plan diagram of the recording media 2 when the recording media 2 of FIG. 1 is a SD card.

FIG. 13 is a format diagram showing a format of a device information signal S2A according to a modified embodiment of the first embodiment of the present disclosure.

FIG. 14 is a timing chart showing operation of the communication system of FIG. 1 according to a second embodiment of the present disclosure.

FIG. 15 is a plan diagram showing the cross mark 51 and the text message 52 displayed on the liquid crystal panel 31, and the recording media 2, in step S11 of FIG. 14.

FIG. 16 is a plan diagram showing the mark 53 and the text message 54 displayed on the liquid crystal panel 31, and the recording media 2, in step S15A of FIG. 14.

FIG. 17 is a timing chart showing operation of the communication system of FIG. 1 according to a third embodiment of the present disclosure.

FIG. 18 is a plan diagram showing the text message 55 displayed on the liquid crystal panel 31, an output state of a beep sound from a speaker 34, a light-emitting state of a light-emitting element 35, and the recording media 2, in step S17A of FIG. 17.

FIG. 19 is a plan diagram showing the text message 55 displayed on the liquid crystal panel 31, the output state of the beep sound from the speaker 34, and the recording media 2, in step S17A of FIG. 17 according to a first modified embodiment of the third embodiment of the present disclosure.

FIG. 20 is a plan diagram showing the text message 55 displayed on the liquid crystal panel 31, the light-emitting state of the light-emitting element 35, and the recording media 2, in step S17A of FIG. 17 according to a second modified embodiment of the third embodiment of the present disclosure.

FIG. 21 is a timing chart showing operation of the communication system of FIG. 1 according to a fourth embodiment of the present disclosure.

FIG. 22 is a plan diagram showing the cross mark 51 and the text message 55 displayed on the liquid crystal panel 31, the output state of the beep sound from the speaker 34, the light-emitting state of the light-emitting element 35, and the recording media 2, in step S17A of FIG. 17.

FIG. 23 is a plan diagram showing the cross mark 51 and the text message 55 displayed on the liquid crystal panel 31, the output state of the beep sound from the speaker 34, and the recording media 2, in step S17A of FIG. 17 according to a first modified embodiment of the fourth embodiment of the present disclosure.

FIG. 24 is a plan diagram showing the cross mark 51 and the text message 55 displayed on the liquid crystal panel 31, the light-emitting state of the light-emitting element 35, and the recording media 2, in step S17A of FIG. 17 according to a second modified embodiment of the fourth embodiment of the present disclosure.

FIG. 25 is a timing chart showing operation of the communication system of FIG. 1 according to a fifth embodiment of the present disclosure.

FIG. 26 is a timing chart showing operation of a communication system provided with the information processing terminal apparatus 1 of FIG. 1 and a connection equipment 2A according to a sixth embodiment of the present disclosure.

FIG. 27 is a flow chart showing an antenna position display process in step S15A of FIG. 26.

FIG. 28 is a plan diagram showing the information processing terminal apparatus 1 and the connection equipment 2A when it is possible to perform the proximity wireless communication between the information processing terminal apparatus 1 and the connection equipment 2A of a camera, in step S16A of FIG. 26.

FIG. 29 is a plan diagram showing the information processing terminal apparatus 1 and the connection equipment 2A when it is possible to perform the proximity wireless communication between the information processing terminal apparatus 1 and the connection equipment 2A of a speaker, in step S16A of FIG. 26.

FIG. 30 is a plan diagram showing the information processing terminal apparatus 1 and the connection equipment 2A when it is possible to perform the proximity wireless communication between the information processing terminal apparatus 1 and the connection equipment 2A of a keyboard, in step S16A of FIG. 26.

FIG. 31 is a plan diagram showing a configuration of an information processing terminal apparatus 1A according to a seventh embodiment of the present disclosure.

FIG. 32 is a plan diagram showing the information processing terminal apparatus 1A of FIG. 31, a mark 56 displayed on the liquid crystal panel 31, and a connection equipment 2B.

FIG. 33 is a plan diagram showing a configuration of an information processing terminal apparatus 1B according to an eighth embodiment of the present disclosure.

FIG. 34 is a block diagram showing the information processing terminal apparatus 1B of FIG. 33, marks 57 and 58 displayed on the liquid crystal panel 31, and the connection equipment 2B.

FIG. 35 is a plan diagram showing the information processing terminal apparatus 1B of FIG. 33, other marks 57A and 58A displayed on the liquid crystal panel 31, and the connection equipment 2B.

FIG. 36A is a plan diagram showing the cross mark 51 displayed on the liquid crystal panel 31, for example, in step S11 of FIG. 6 and the like.

FIG. 36B is a plan diagram showing the mark 53 displayed on the liquid crystal panel 31, for example, in step S15 of FIG. 6 and the like.

FIG. 36C is a plan diagram showing the cross mark 51 displayed on the liquid crystal panel 31 in step S15 of FIG. 6 according to the modified embodiment of the first embodiment of the present disclosure.

FIG. 37A is a plan diagram showing the mark 53 displayed on the liquid crystal panel 31 in step S15 of FIG. 6.

FIG. 37B is a plan diagram showing the mark 53 displayed on the liquid crystal panel 31 in step S15 of FIG. 6 according to the modified embodiment of the first embodiment of the present disclosure.

FIG. 38A is a plan diagram showing the connection equipment 2A of the speaker of FIG. 29 according to the modified embodiment of the sixth embodiment of the present disclosure.

FIG. 38B is a perspective diagram showing a structure of a clip 60 of the connection equipment 2A of FIG. 41A.

FIG. 38C is a plan diagram showing a guide 61 indicating a position where the information processing terminal apparatus 1 is pinched by the clip 60 of the connection equipment 2A of FIG. 41A.

FIG. 38D is a plan diagram showing a state when the information processing terminal apparatus 1 is pinched by the clip 60 using the guide 61 of FIG. 41C.

FIG. 39 is a timing chart showing operation of the communication system of FIG. 1 according to a ninth embodiment of the present disclosure.

FIG. 40A is a plan diagram showing the mark 53 displayed on the liquid crystal panel 31 having a large screen size and the recording media 2, in step S15A of FIG. 14.

FIG. 40B is a plan diagram showing the mark 53 displayed on the liquid crystal panel 31 having a small screen size and the recording media 2, in step S15A of FIG. 14.

FIG. 40C is a plan diagram showing the mark 53 displayed on the liquid crystal panel 31 having a small screen size and the recording media 2, in step S15 of FIG. 36.

FIG. 41A is one table for using when a display size of the mark 53 is adjusted according to a screen size of the liquid crystal panel 31, in step S60 of FIG. 36.

FIG. 41B is another table for using when a display size of the mark 53 is adjusted according to a screen size of the liquid crystal panel 31, in step S60 of FIG. 36.

### DESCRIPTION OF EMBODIMENTS

Embodiments of the present disclosure will be described below with reference to the drawings. It is noted that like components are denoted by the same reference signs.

### First Embodiment

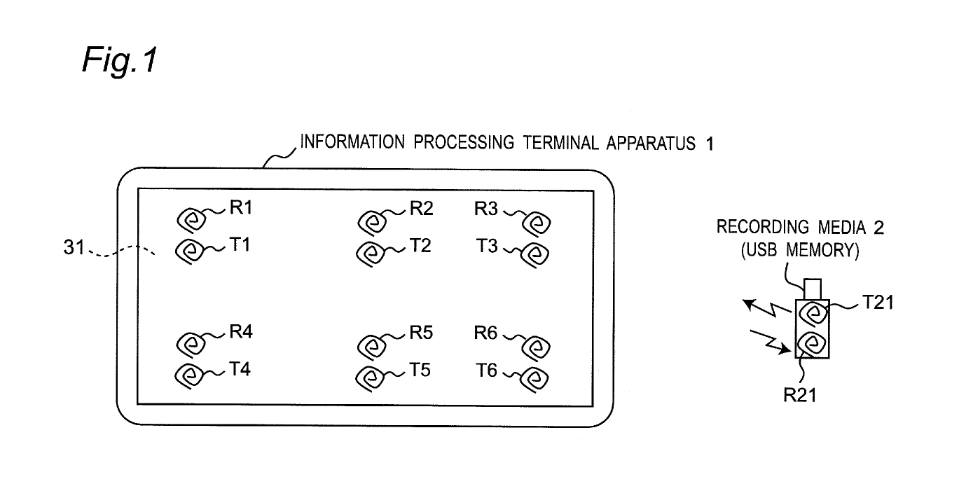

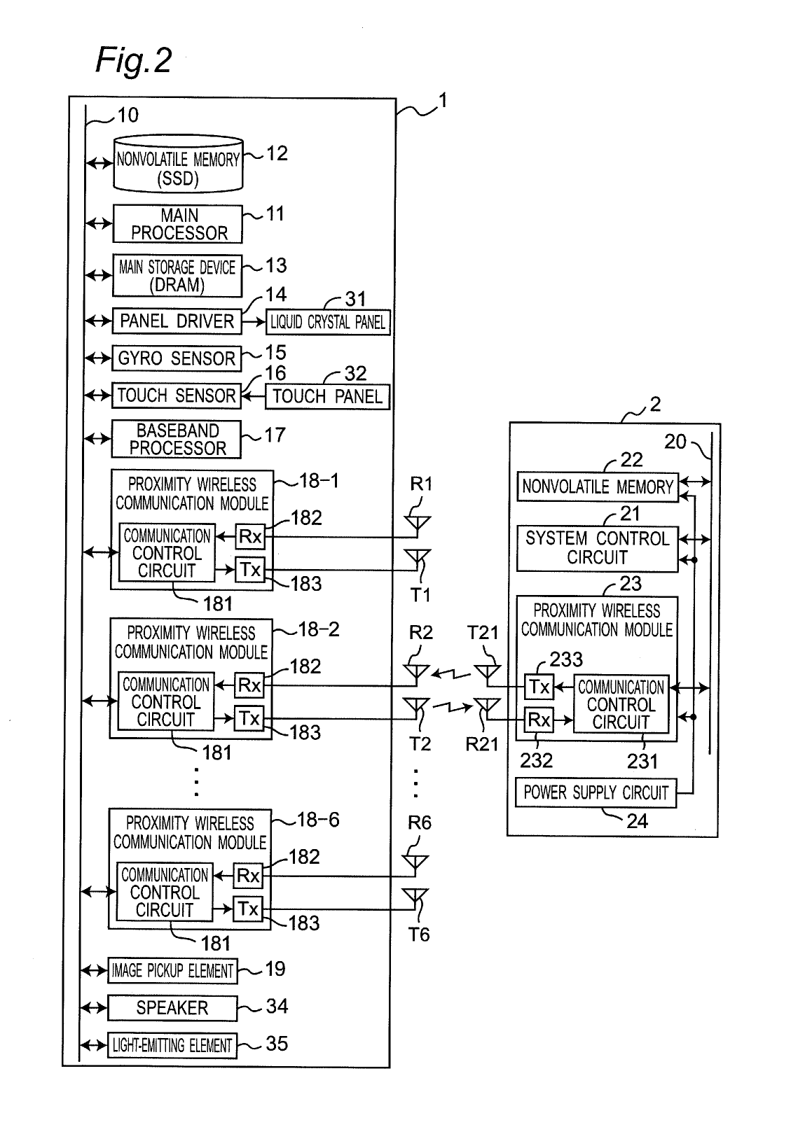

FIG. 1 is a plan diagram showing a configuration of a communication system provided with an information processing terminal apparatus 1 and a recording media 2 according to a first embodiment of the present disclosure. FIG. 2 is a block diagram showing configurations of the information processing terminal apparatus 1 and the recording media 2 of FIG. 1. Referring to FIG. 1, the communication system according to the present embodiment is configured to include an information processing terminal apparatus 1 of a tablet terminal, and a recording media 2 such as a USB memory. Referring to FIG. 2, the information processing terminal apparatus 1 is configured to include a main processor 11 of a CPU (Central Processing Unit), a SSD (Solid State Drive) of a nonvolatile memory, a main storage device 13 of a DRAM, a liquid crystal panel 31, a panel driver 14 for driving the liquid crystal panel 31, a gyro sensor 15, a touch panel 32, a touch sensor 16 for detecting a touch position at the touch panel 32, a baseband processor 17, proximity wireless communication modules 18-1 to 18-6, an image pickup element 19, a speaker 34, a light-emitting element 35, a bus 10, antenna coils for transmitting (hereinafter, it is referred to as antennas) T1 to T6, and antenna coils for receiving (hereinafter, it is referred to as antennas) R1 to R6. In addition, the proximity wireless communication modules 18-n (n=1, 2, . . . , 6) are configured to include communication control circuits 181, input and output circuits 182 for driving the antennas Rn (n=1, 2, . . . , 6), and input and output circuits 183 for driving the antennas Tn (n=1, 2, . . . , 6), respectively.

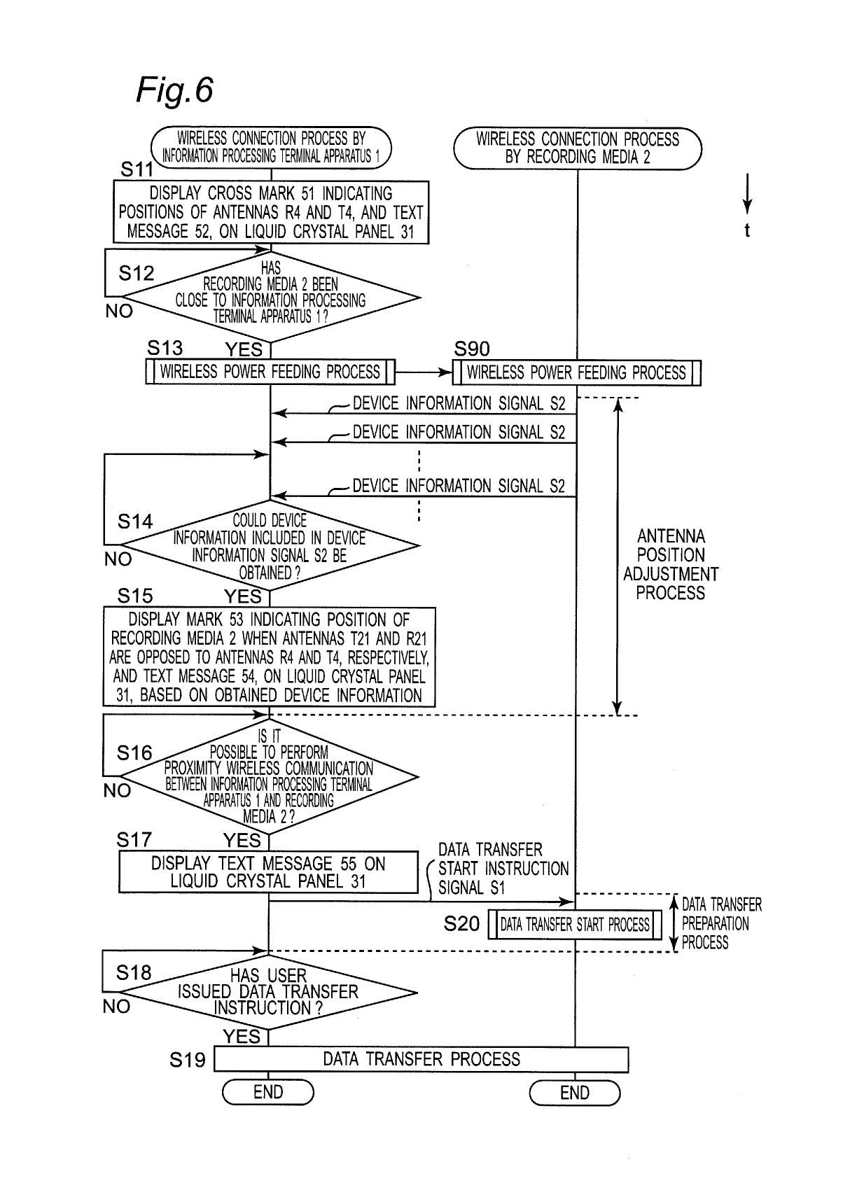

Referring to FIG. 2, the main processor 11 is connected to each of the parts 12 to 17, 18-1 to 18-6, 19, 34, and 35 of the other hardware via the bus 10, and controls them. In addition, the main processor 11 executes various kinds of functions of software. The nonvolatile memory 12 stores in advance various kinds of software programs such as a wireless connection process program of FIG. 6, which is necessary for operating the information processing terminal apparatus 1 and executed by the main processor 11. In addition, the main storage device 13 is used as a working area of the main processor 11, and temporarily stores data generated when the program is executed.

In addition, the baseband processor 17 performs a predetermined process such as a communication protocol process for transmission data to be input, and outputs the processed data to the communication control circuit 181 of the proximity wireless communication module selected from the proximity wireless communication modules 18-1 to 18-6 by the main processor 11. In addition, the base band processor 17 extracts received data included in received signals from the communication control circuits 181 of the proximity wireless communication modules 18-1 to 18-6, and outputs the extracted received data to the main processor 11. The communication control circuits 181 of each of the proximity wireless communication modules 18-n (n=1, 2, . . . , 6) performs a predetermined encoding process for the transmission data from the baseband processor 17, modulates a predetermined carrier wave signal to a wireless signal according to the encoded transmission data, and wirelessly transmits from the antennas Tn (n=1, 2, . . . , 6) via the input and output circuits 183. In addition, the communication control circuit 181 of each of the proximity wireless communication modules 18-n (n=1, 2, . . . , 6) decodes the wireless signal received by the antennas Rn (n=1, 2, . . . , 6), serial to parallel-converts the same signals, and outputs the same signals to the baseband processor 17. In addition, the information processing terminal apparatus 1 is further provided with a transmission antenna (not shown), and wirelessly feeds an electric power to the recording media 2 by performing a predetermined wireless feeding process. In the present embodiment, it is noted that the carrier wave signal is modulated according to the transmission data. However, the embodiment of the present disclosure is not limited thereto. For example, the carrier wave signal is not modulated, and the transmission data may be directly transmitted.

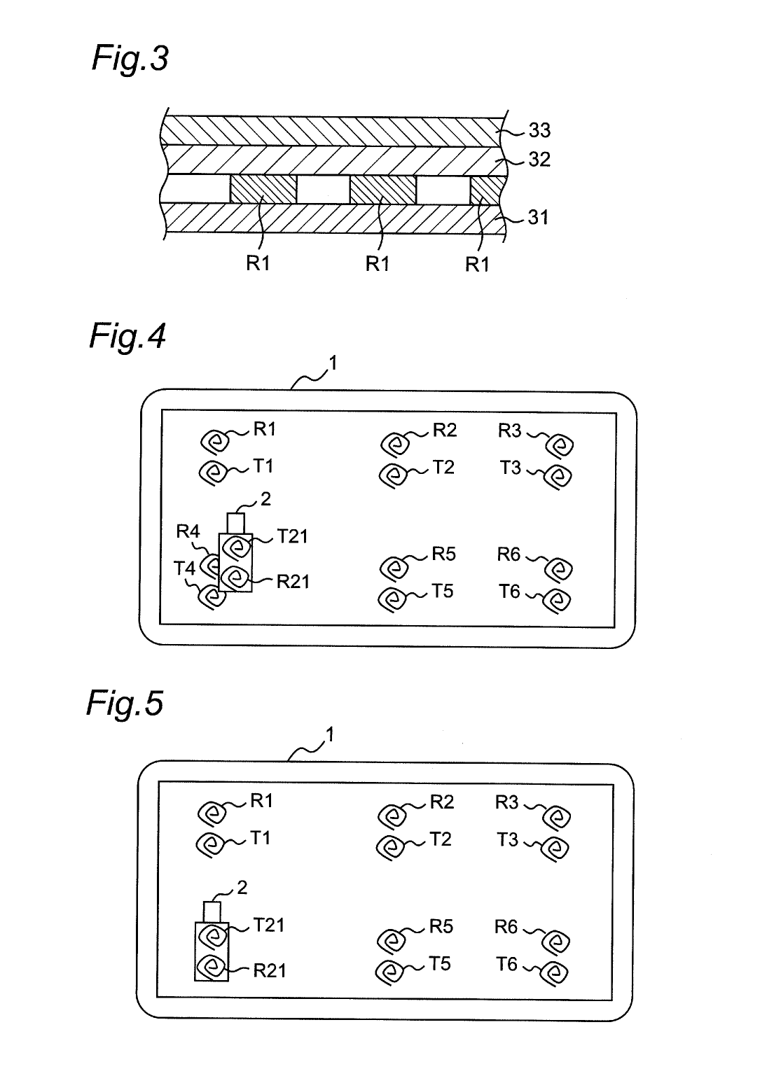

Next, referring to FIGS. 1 and 3, the positions where the antennas R1 to R6, T1 to T6 are located are described. FIG. 3 is a partially cross sectional view cutting across an antenna R1 of the information processing terminal apparatus 1 of FIG. 1. As illustrated in FIG. 1, the liquid crystal panel 31 has substantially the same size as that of top surface of the information processing terminal apparatus 1, and the six pairs of antennas Rn and Tn (n=1, 2, . . . , 6) are formed at the six positions on the liquid crystal panel 31, respectively. In this case, the antennas R1 to R6 have the same shape to each other, and the antennas T1 to T6 have the same shape to each other. In addition, as illustrated in FIG. 3, each of the antennas R1 to R6 and T1 to T6 is formed of a conductive pattern of a transparent conductive film on a front surface of the liquid crystal panel 31 using an indium tin oxide (ITO) or polyethylenedioxythiophene (PEDOT) and the like. Further, the touch panel 32 is provided on each of the antennas R1 to R6 and the antennas T1 to T6, and a protection film 33 of a glass or a resin is formed on the top surface of the touch panel 32.

On the other hand, referring to FIG. 2, the recording media 2 is configured to include a system control circuit 21, a nonvolatile memory 22 of a NAND-type flash memory, a proximity wireless communication module 23, a power supply circuit 24, an transmission antenna T21, an receiving antenna R21, and a bus 20. In addition, the proximity wireless communication module 23 is configured to include a communication control circuit 231, an input and output circuit 232 for driving the antenna R21, an input and output circuit 233 for driving the antenna T21.

Referring to FIG. 2, the system control circuit 21 is connected to each of the parts 22 to 24 of the other hardware via the bus 20, and controls them. Further, the system control circuit 21 executes various kinds of functions of software. The nonvolatile memory 22 stores in advance various kinds of software programs such as the wireless connection process program of FIG. 6, which is necessary for operating the recording media 2 and executed by the system control circuit 21. The power supply circuit 24 is configured to include a power-receiving antenna and a power-receiving circuit, and the power supply circuit 24 receives an electric power from the transmission antenna (not shown) of the information processing terminal apparatus 1 by performing a predetermined wireless feeding process. Then, a capacitor within the power-receiving circuit is charged by the received power, and the system control circuit 21, the nonvolatile memory 22, and the proximity wireless communication module 23 are fed from the capacitor.

The communication control circuit 231 performs a predetermined encoding process for the transmission data from the system control circuit 21, modulates a wireless signal according to the encoded transmission data to generate a modulated wireless signal, and wirelessly transmits from the antenna T21 via the input and output circuit 233. In addition, the communication control circuit 231 decodes the wireless signal received by the antenna R21, and serial to parallel converts the same signal and outputs the same signal to the system control circuit 21.

In addition, the antenna T21 has the same shape as those of the antennas R1 to R6, and the antenna R21 has the same shape as those of the antennas T1 to T6. Further, the antennas T21 and R21 is located within the recording media 2 so that the antennas T21 and R21 are opposed to the antennas Rn and Tn (n=1, 2, . . . , 6), respectively.

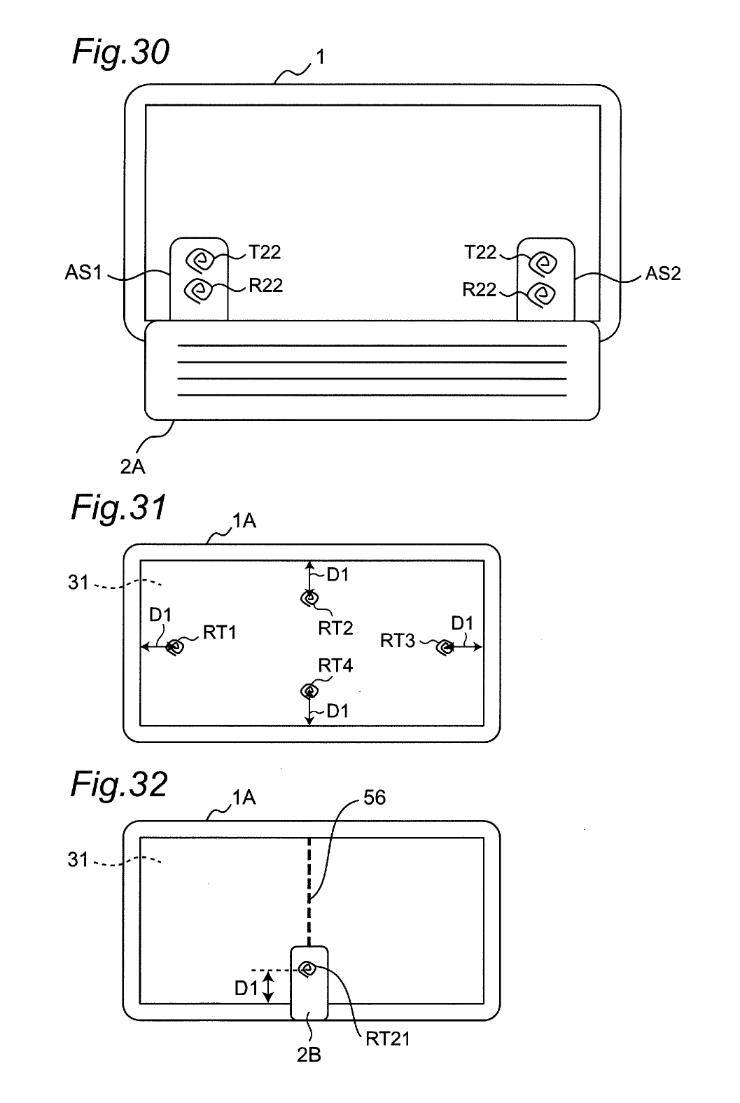

Referring to FIG. 1 and each of the following drawings, it is noted that the antenna coils of the antennas R1 to R6 and T1 to T6, and RT1 to RT4 (See FIGS. 31 to 35) are represented by solid lines, respectively. However, since these antennas are formed of the transparent conductive films, in fact, these antennas can not be seen from a user. In addition, in FIG. 1 and each of the following drawings, the antenna coils of the antennas R21 and T21, and R22 and T22 (See FIGS. 29 and 30) are represented by the solid lines, respectively. However, since these antennas are provided inside the recording media 2 or a connection equipment 2A or 2B, in fact, these antennas can not be seen from the user.

FIG. 4 is a top diagram showing a position of the recording media 2 when it is not possible to perform a proximity wireless communication between the information processing terminal apparatus 1 and the recording media 2 of FIG. 1. FIG. 5 is a top diagram showing a position of the recording media 2 when it is possible to perform the proximity wireless communication between the information processing terminal apparatus 1 and the recording media 2 of FIG. 1. It is necessary for the two antennas to be opposed to each other to perform the proximity wireless communication between the two antennas by utilizing a neighborhood electromagnetic field of a short distance equal to or less than a wavelength of an electromagnetic wave. This is because an electric field and a magnetic field drastically become small in inverse proportion to a cube of the distance from the antenna. For example, as illustrated in FIG. 4, when the position of the antenna T21 shifts from the position of the antenna R4, the antenna T21 and the antenna R4 are inductively coupled to each other. Accordingly, it is not possible to perform the wireless communication using the antennas T21 and R4. Similarly, it is not possible to perform the wireless communication using the antennas R21 and T4. On the other hand, as illustrated in FIG. 5, when the antenna T21 is opposed to the antenna R4, and when the antenna R21 is opposed to the antenna T4, the antennas T21 and R4 are inductively coupled with the antennas R21 and T4, respectively, and a wireless transmission channel for the proximity wireless communication can be formed. At this time, in general, a pair of antennas can realize a data transmission speed having a speed more than 1 Gbps.

As described above, there is such a problem that it is not possible to perform the proximity wireless communication when a pair of antennas is not adjusted so as to be opposed the each other. However, there is such an advantage that it is possible to specify the other communication party only by forming the wireless transmission channel using the opposed antennas, and realize the wireless communication without any interference. Accordingly, the communication system according to the present embodiment can realize a high confidentiality, and is appropriate for the use of a connector.

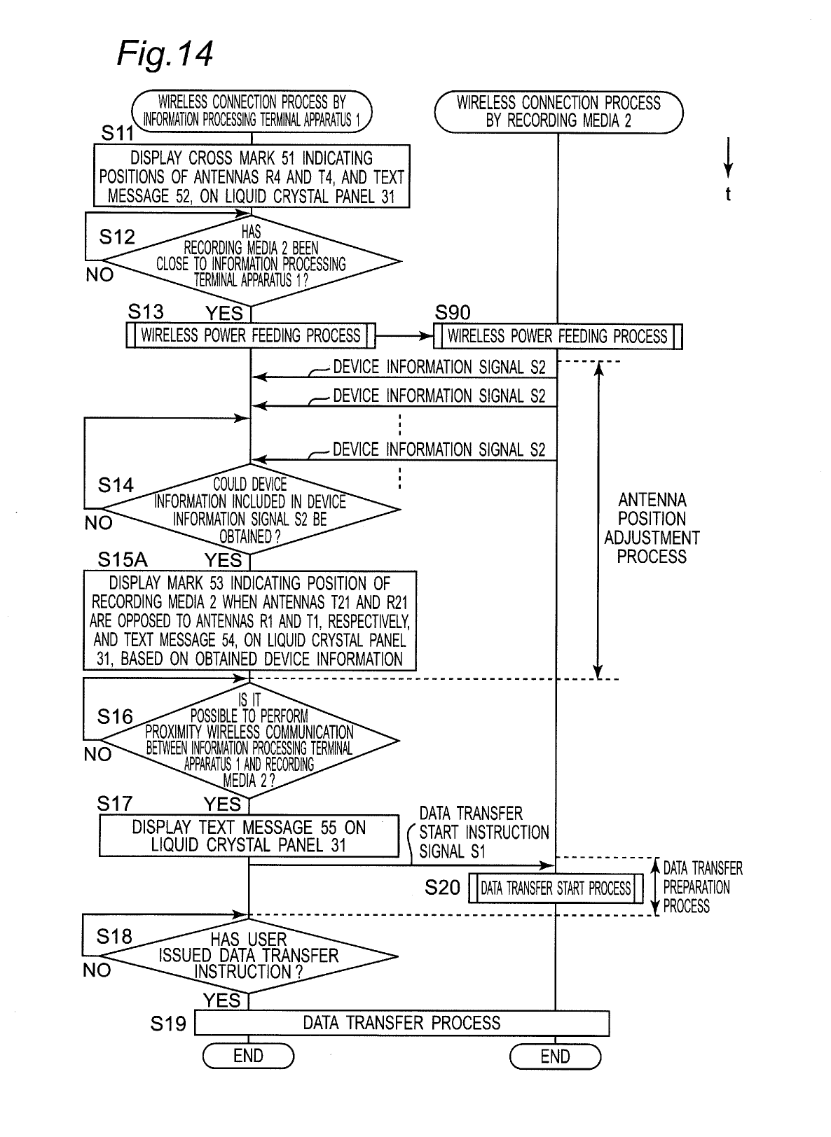

FIG. 6 is a timing chart showing operation of the communication system of FIG. 1. In the timing chart of FIG. 6 and timing charts of the following FIGS. 14, 17, 21, and 25, it is noted that the main body of the operation of the information processing terminal apparatus 1 is the main processor 11, the main body of the operation of the recording media 2 is the system control circuit 21. However, their descriptions are omitted. Referring to FIG. 1, the nonvolatile memory 12 stores in advance a program of a recording media connection application software for performing the proximity wireless communication via the antennas R4, T4, T21, and R21 between the information processing terminal apparatus 1 and the recording media 2. When the user performs predetermined operation for activating the recording media connection application software, in response to this, the information processing terminal apparatus 1 executes the wireless connection process of FIG. 6.

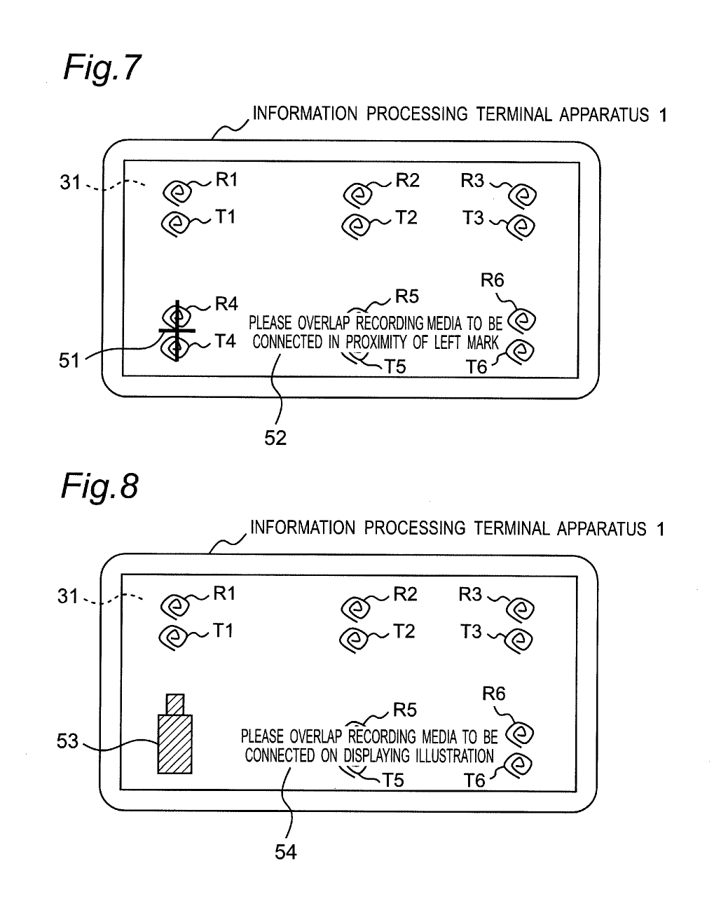

First of all, the information processing terminal apparatus 1 selects the antennas R4 and T4 as device information acquisition antennas for receiving a device information signal S2 as described in detail below when the wireless connection process of FIG. 6 starts. In addition, the information processing terminal apparatus 1 selects the antennas R4 and T4 as data transfer antennas for transferring data other than the device information signal S2 and a connection control code signal Sc as described in detail below. Then, in step S11 of FIG. 6, the information processing terminal apparatus 1 controls the liquid crystal panel 31 to display a cross mark 51 indicating positions of the antennas R4 and T4 for obtaining the device information, and a text message 52, on the liquid crystal panel 31. FIG. 7 is a plan diagram showing a cross mark 51 and a text message 52 displayed on the liquid crystal panel 31, in step S11 of FIG. 6. As illustrated in FIG. 7, the cross mark 51 is displayed so that an intersection of the cross mark 51 coincides with a middle point between central points of the antennas R4 and T4. In addition, such a text message 52 that “please overlap the recording media to be connected in the proximity of the left mark” is displayed on the right side of the cross mark 51. Next, in step S12 of FIG. 6, when the recording media 2 is close to the information processing terminal apparatus 1, the information processing terminal apparatus 1 judges whether or not it is possible to wirelessly feed an electric power to the recording media 2, and if it is YES in step S12, the process proceeds to step S13. On the other hand, if it is NO in step S12, the process of step S12 is executed repeatedly. In step S13, the information processing terminal apparatus 1 performs a predetermined wireless feeding process to transmit the electric power to the recording media 2. On the other hand, in step S90, the recording media 2 performs a predetermined wireless feeding process to receive the electric power from the information processing terminal apparatus 1. When the recording media 2 starts to receive from the information processing terminal apparatus 1, the recording media 2 wirelessly transmits the device information signal S2 repeatedly at predetermined time intervals by using the antenna T21. In addition, the recording media 2 wirelessly transmits a connection control code signal Sc (See FIG. 11) including a predetermined code for judging whether or not the wireless connection is established, and predetermined data for an alignment for adjusting a size of serially-transferred data to a predetermined number unit.

FIG. 10 is a format diagram showing a format of the device information signal S2 of FIG. 6. As illustrated in FIG. 10, the device information signal S2 is not any user data stored in the nonvolatile memory 22 by the user, and includes an identification code for identifying the recording media 2 and the device information. In this case, the device information includes information of a device shape indicating a shape of the recording media 2 and an antenna position indicating each of the positions of the antennas T21 and R21 of the recording media 2.

FIG. 11 is a timing chart showing a communication state when the device information signal S2 of FIG. 6 is repeatedly transmitted from the recording media 2 to the information processing terminal apparatus 1 of FIG. 1. During a time period from such a timing that the user performs predetermined operation for activating the recording media connection application software to a timing that the user overlaps the recording media 2 on the cross mark 51 of FIG. 7, the antennas T21 and R4 can not be completely wirelessly connected to each other, and the antennas R21 and T4 can not be completely wirelessly connected to each other. Accordingly, as illustrated in FIG. 11, the most of the above time period is covered by communication error time periods 101. However, the size of data included in the device information signal S2 is relatively small. Accordingly, the information processing terminal apparatus 1 can receive a part of the device information signal S2 in each of time periods 102 when the wireless communication can be normally performed by repeatedly transmitting the device information signal S2 from the recording media 2.

In step S14 of FIG. 6, the information processing terminal apparatus 1 judges whether or not it is possible to obtain the device information included in the device information signal S2, and if it is YES, the process proceeds to step S15. On the other hand, if it is NO, the process of step S14 is repeatedly performed. In step S15, the information processing terminal apparatus 1 controls the liquid crystal panel 31 to display a mark 53 indicating a position of the recording media 2 when the data transfer antennas T21 and R21 are opposed to the antennas R4 and T4, and a text message 54 on the liquid crystal panel 31, based on the obtained device information. FIG. 8 is a plan diagram showing the mark 53 and the text message 54 displayed on the liquid crystal panel 31, in step S15 of FIG. 6. As illustrated in FIG. 8, the mark 53 indicating the position of the recording media 2 and such a text message 54 that “please overlap the recording media to be connected on displaying illustration” are displayed.

Following step S15 of FIG. 6, in step S16, the information processing terminal apparatus 1 judges whether or not it is possible to perform the proximity wireless communication between the information processing terminal apparatus 1 and the recording media 2, and if it is YES, the process proceeds to step S17. On the other hand, if it is NO, the process of step S16 is repeatedly performed. Concretely speaking, when a communication error rate between the information processing terminal apparatus 1 and the recording media 2 is equal to or less than a predetermined threshold value, the information processing terminal apparatus 1 judges that it is possible to perform the proximity wireless communication between the information processing terminal apparatus 1 and the recording media 2. On the other hand, when the communication error rate is larger than the predetermined threshold value, the information processing terminal apparatus 1 judges that it is not possible to perform the proximity wireless communication between the information processing terminal apparatus 1 and the recording media 2. When the user overlaps the recording media 2 on the mark 53 of FIG. 8, since the antenna T21 is opposed to the data transfer antenna R4, and the antenna R21 is opposed to the data transfer antenna T4, then the communication error rate becomes equal or less than the predetermined threshold value. Accordingly, the information processing terminal apparatus 1 judges that it is YES in step S16.

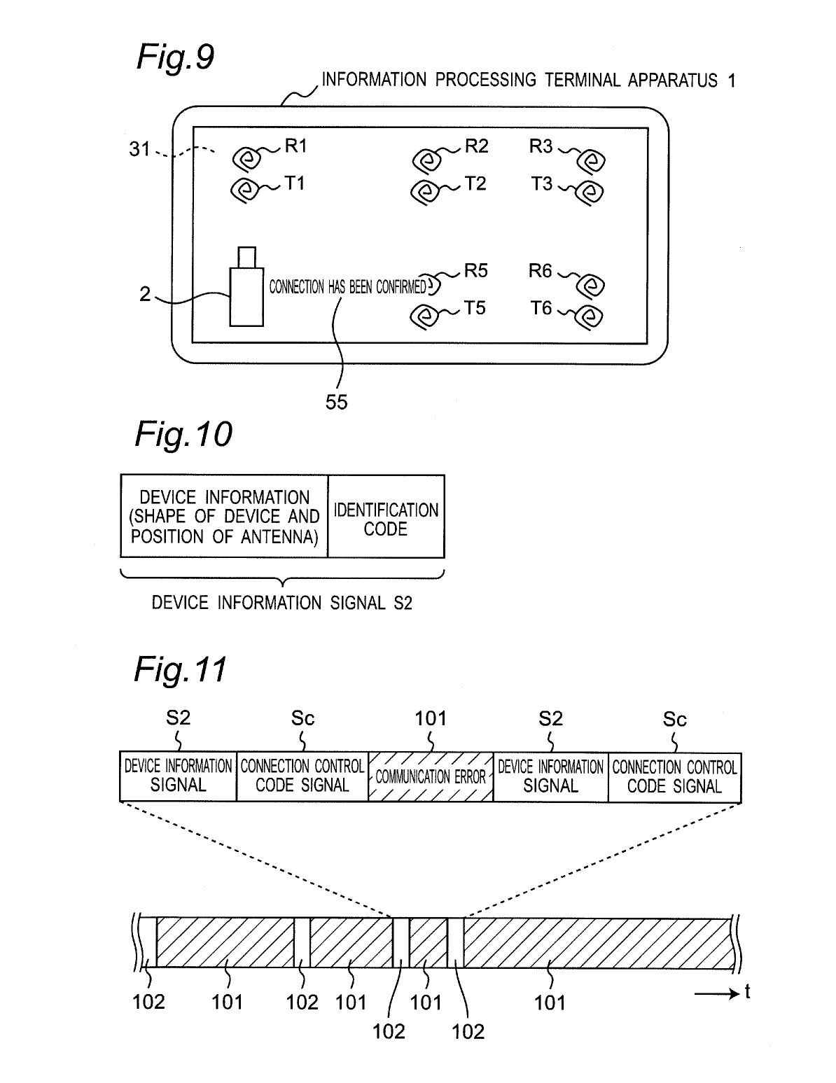

In step S17, the information processing terminal apparatus 1 controls the liquid crystal panel 31 to display a text message 55 on the liquid crystal panel 31. It is noted that the process of step S17 is referred to as a position adjustment completion notice process. FIG. 9 is a plan diagram showing a text message 55 displayed on the liquid crystal panel 31 and the recording media 2, in step S17 of FIG. 6. As illustrated in FIG. 9, such a text message 55 that “connection has been confirmed” is displayed on the liquid crystal panel 31. Further, the information processing terminal apparatus 1 transmits the data transfer start instruction signal S1 to the recording media 2. In response to this, the recording media 2 performs a predetermined data transfer start process for starting to transfer data to the information processing terminal apparatus 1. In addition, in step S18 followed by step S17, the information processing terminal apparatus 1 judges whether or not the user has performed predetermined operation for instructing to perform data transfer between the information processing terminal apparatus 1 and the recording media 2, and if it is YES, the process proceeds to step S19. On the other hand, if it is NO, the process of step S18 is repeatedly performed. In step S19, the information processing terminal apparatus 1 performs the data transfer via a pair of the antennas T21 and R4 and a pair of the antennas R21 and T4, between the information processing terminal apparatus 1 and the recording media 2. For example, in step S19, the information processing terminal apparatus 1 reads out data stored in the recording media 2 in response to a data read-out instruction from the user, and transmits data in the nonvolatile memory 12 to the recording media 2 in response to a data write-out instruction from the user. In addition, when the data transfer rate is larger than the threshold value as described above by shifting the position of the recording media 2 during the process of data transfer, the information processing terminal apparatus 1 performs again from step S11 of the wireless connection process of FIG. 6.

Referring to FIG. 6, it is noted that the process of the transmission process of the device information signal S2 by the recording media 2 to the process of step S15 of the information processing terminal apparatus 1 is referred to as an antenna position adjustment process. In addition, the process of the transmission process of the data transfer start instruction signal S1 by the information processing terminal apparatus 1 to the process of the data transfer start process of step S20 by the recording media 2 is referred to as a data transfer preparation process.

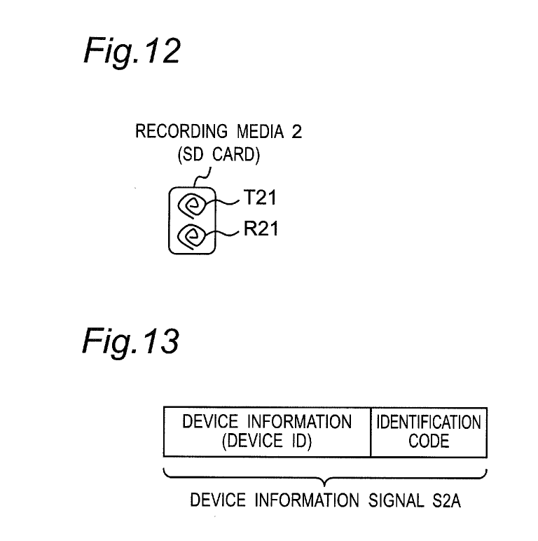

In the present embodiment, it is noted that the recording media 2 is a USB memory. However, the present disclosure is not limited thereto. For example, the recording media 2 may be the other recording media such as a SD card. FIG. 12 is a plan diagram of the recording media 2 when the recording media 2 of FIG. 1 is the SD card. The recording media 2 of FIG. 12 has a configuration similar to that of the recording media 2 of FIG. 2, and includes the antennas T21 and R21. At this time, the mark 53 (See FIG. 8) displayed on the liquid crystal panel 31 in step S15 of FIG. 6 has the shape of the SD card.

As described above, the information processing terminal apparatus 1 is characterized in that the information processing terminal apparatus 1 is provided with the liquid crystal panel 31 for displaying predetermined information, the antennas R1 to R6, and T1 to T6 formed of the transparent conductive film on the front surface of the liquid crystal panel 31, and the main processor 11 (control means) for performing the proximity wireless communication between the antennas T21, R21 and the data transfer antennas R4, T4 when the antennas R4 and T4 are selected from the antennas R1 to R6, and T1 to T6, when the antenna T21 is opposed to the antenna R4, and when the antenna R21 is opposed to the antenna T4.

Accordingly, since the antennas R1 to R6 and T1 to T6 are provided on the liquid crystal panel 31, the information processing terminal apparatus 1 can be wirelessly connected to the recording media 2. That is, the pairs of antennas Tn and Rn (n=1, 2, . . . , 6) operate as contactless connectors for transferring data, respectively. Accordingly, the information processing terminal apparatus 1 can perform the data transfer between the information processing terminal apparatus 1 and the recording media 2 without any terminals for wirely connecting the recording media 2 to the information processing terminal apparatus 1. Accordingly, it is possible to provide the information processing terminal apparatus 1 smaller and thinner than that of the prior art, and realizing the waterproof property and the designability higher than that of the prior art. In addition, the numbers of physical buttons and connectors can be smaller than those of the prior art, and therefore, the failure rate of the mechanical components can be lower than that of the prior art.

In addition, as illustrated in FIG. 8, the information processing terminal apparatus 1 displays the mark 53 indicating the position of the recording media 2 when the antenna T21 is opposed to the antenna R4, when the antenna R21 is opposed to the antenna T4, and when it is possible to perform the wireless communication between the information processing terminal apparatus 1 and the recording media 2. Accordingly, the user need only use the mark 53 as the guide of the recording media 2, and put the recording media 2 on the mark 53 without any dependence on the type of the recording media 2. That is, the user puts the recording media 2 so as to overlap the recording media 2 on the mark 53. Accordingly, the stable wireless connection can be established when the antenna T21 is opposed to the antenna R4, and when the antenna R21 is opposed to the antenna T4.

Conventionally, there is such a well-known wireless feeding technique that detects positions of antennas of equipment to be fed with an electric power, and moves moving coils to the detected positions so that the moving coils are opposed to the antennas. In this case, since the mechanical components for moving the moving coils are necessary, the miniaturization of the equipment can not be realized. In contrast, according to the present embodiment, since the information processing terminal apparatus 1 is provided with only the antennas R1 to R6 and T1 and T6, as compared with the case using the technique of the moving coils, it is possible to miniaturize the information processing terminal apparatus 1 without damaging the designability thereof.

In addition, in the present embodiment, the antennas R4 and T4 are selected as the device information acquisition antenna and the data transfer antenna. However, the present disclosure is not limited thereto. For example, pairs of antennas other than the pair of antennas R4 and T4 may be selected as the device information acquisition antenna or the data transfer antenna.

Further, referring to FIG. 8, the mark 53 is an illustration of the recording media 2. However, the present disclosure is not limited thereto. For example, the other mark such as a frame surrounding the recording media 2 may be used for indicating a position where the recording media 2 is put.

Furthermore, the device information included in the device information signal S2 includes the device shape information indicating the shape of the recording media 2 and the antenna position information indicating each of the positions of the antennas T21 and R21. However, the present disclosure is not limited thereto. FIG. 13 is a format diagram showing a format of a device information signal S2A according to a modified embodiment of the first embodiment of the present disclosure. The device information within the device information signal S2A is a device ID of the recording media. In this case, a table indicating relations among the device ID, the device shape indicating the shape of the recording media 2, and the antenna positions indicating each of the positions of the antennas T21 and R21 in the recording media 2 is stored in advance in the nonvolatile memory 12 or a storage device on a network. Then, the information processing terminal apparatus 1 obtains the device shape of the recording media 2, and each of the positions of the antennas T21 and R21 with reference to this table based on the device ID.

In addition, the device shape information for displaying the mark 53 of the recording media 2 may be drawing information of the recording media 2. In addition, the device shape information may not be an accurate shape of the recording media 2, but may be a size information of the information processing terminal apparatus 1 such as a longitudinal length and a length in a short side direction.

Further, in the present embodiment, one recording media 2 is wirelessly connected to the information processing terminal apparatus 1. However, the present disclosure is not limited thereto. For example, a plurality of recording media 2 may be wirelessly connected to the information processing terminal apparatus 1. In this case, it is possible to perform the data transfer between one recording media 2 and another recording media 2 via the information processing terminal apparatus 1.

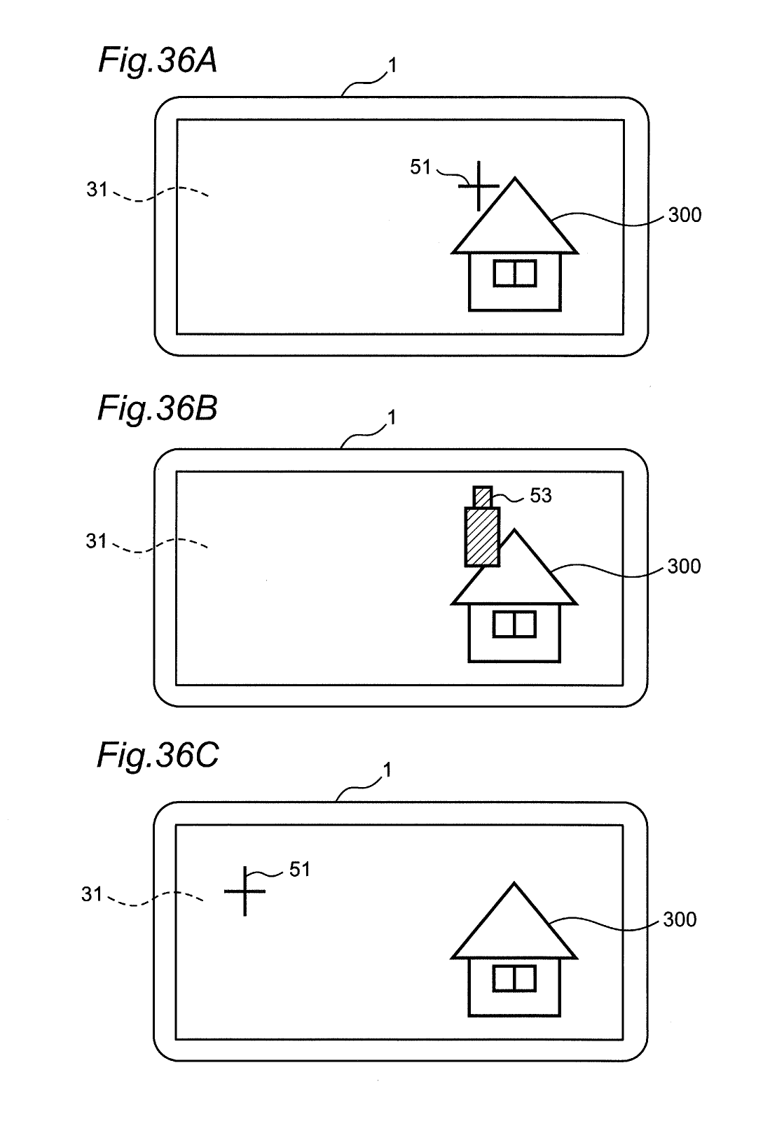

Furthermore, in the present embodiment, as illustrated in FIG. 36A, there is a case where the cross mark 51 is displayed in the proximity of an image 300 displayed on the liquid crystal panel 31. In this case, as illustrated in FIG. 36B, the mark 53 indicating the position of the recording media 2 is displayed so as to overlap the mark 53 on the image 300. Then, there is such a problem that a part of the image 300 can not seen. Accordingly, in the modified embodiment of the present embodiment, as illustrated in FIG. 36C, the main processor 11 (control means) controls display data to display the cross mark 51 so as not to overlap the cross mark 51 on the image 300. FIG. 36C is a plan diagram showing the cross mark 51 displayed on the liquid crystal panel 31 in step S15 of FIG. 6 according to the modified embodiment of the first embodiment of the present disclosure. Referring to FIG. 36C, the cross mark 51 indicating the positions of the antennas R1 and T1, which are the farthest away from the antennas R1 and T1, is displayed on the liquid crystal panel 31. Accordingly, the mark 53 indicating the position of the recording media 2 does not overlap the image 300.

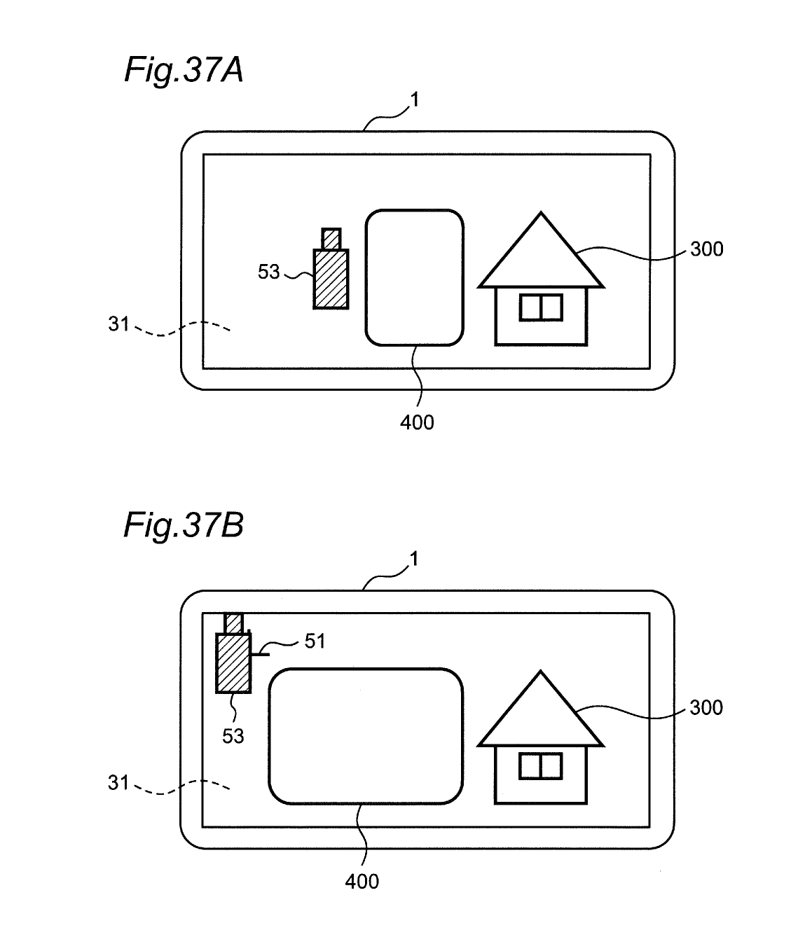

In addition, in the present embodiment, as illustrated in FIG. 37A, there is such a problem that a drawing space 400 between the mark 53 and the image 300 can not be sufficiently secured according to the location where the mark 53 is displayed. Accordingly, in the modified embodiment of the present embodiment, as illustrated in FIG. 37B, the main processor 11 (control means) controls display data to display the cross mark 51 at the edge of the liquid crystal panel 31 so as to broaden the drawing space 400 between the image 300 and the mark 53. That is, the mark 53 indicating the position of the connection equipment such as the recording media 2 is displayed at the edge of the liquid crystal panel 31 of displaying means. FIG. 37B is a plan diagram showing the mark 53 displayed on the liquid crystal panel 31 in step S15 of FIG. 6 according to the modified embodiment of the first embodiment of the present disclosure. Referring to FIG. 37B, the cross mark 51 indicating the positions of the antennas R1 and T1, which are the farthest away from the image 300, is displayed on the liquid crystal panel 31. Accordingly, the drawing space 400 between the image 300 and the mark 53 becomes broader.

It is noted that each of the modified embodiments of the present embodiment as described above can be applied in each of embodiments and modified embodiments thereof as described below.

### Second Embodiment

FIG. 14 is a timing chart showing operation of the communication system of FIG. 1 according to a second embodiment of the present disclosure. As compared with the timing chart of FIG. 6, the timing chart of FIG. 14 is configured to include step S15A instead of step S15. In the present embodiment, when the wireless connection process of FIG. 14 starts, the information processing terminal apparatus 1 selects the antennas R4 and T4 as the device information acquisition antennas, and selects the antennas R1 and T1 as the data transfer antennas. In step S15A, the information processing terminal apparatus 1 controls the liquid crystal panel 31 to display the mark 53 indicating the position of the recording media 2 when the antennas T21 and R21 overlap the antennas R1 and T1, respectively, and the text message 54 on the liquid crystal panel 31 based on the obtained device information.

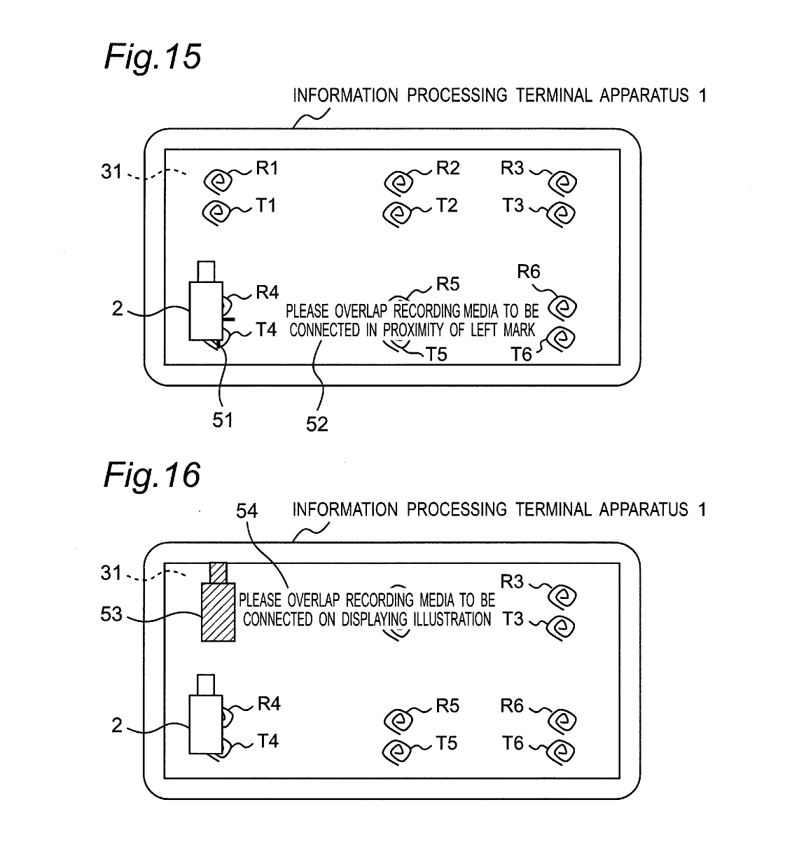

FIG. 15 is a plan diagram showing the cross mark 51 and the text message 52 displayed on the liquid crystal panel 31, and the recording media 2, in step S11 of FIG. 14. When the cross mark 51 is displayed in step S11, the user overlaps the recording media 2 on the cross mark 51. Then, the information processing terminal apparatus 1 receives the device information signal S2 via the antennas T21 and R4 from the recording media 2. FIG. 16 is a plan diagram showing the mark 53 and the text message 54 displayed on the liquid crystal panel 31, and the recording media 2, in step S15A of FIG. 14. As illustrated in FIG. 16, the mark 53 of the recording media 2 is displayed on the antennas R1 and T1, and the user moves the recording media 2 onto the mark 53. Then, the data transfer process between the information processing terminal apparatus 1 and the recording media 2 can be performed via the antennas R1 and T1.

According to the second embodiment, after the recording media 2 is placed on the cross mark 51 indicating the positions of the data transfer antennas R4 and T4, the mark 53 of the recording media 2 is displayed substantially at the same position as that of the cross mark 51. Accordingly, the most of the mark 53 is hidden by the recording media 2, and then, it is difficult to see the mark 53. According to the present embodiment, the antennas R1 and T1, which are different from the device information acquisition antennas R4 and T4, are selected as the data transfer antennas. Accordingly, the mark 53 is displayed at the position, which is different from the position of the cross mark 51. Accordingly, it is possible to further improve the operability than that of the first embodiment.

### Third Embodiment

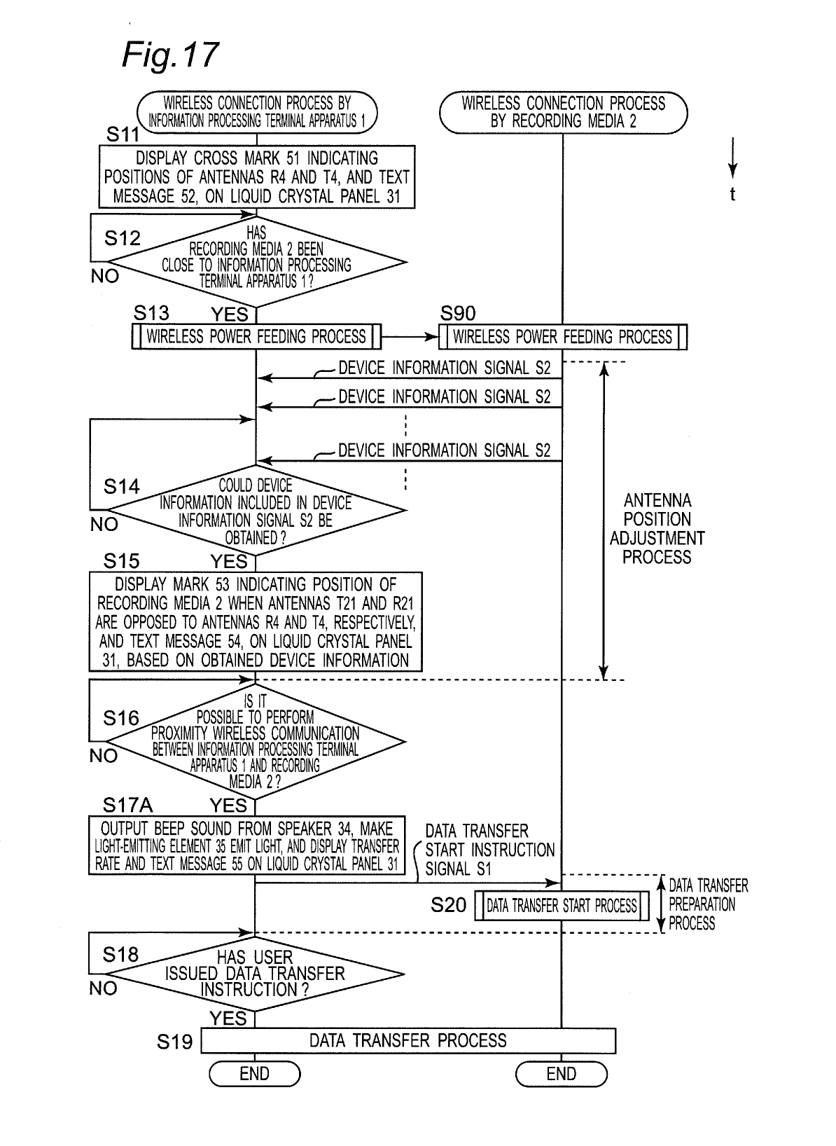

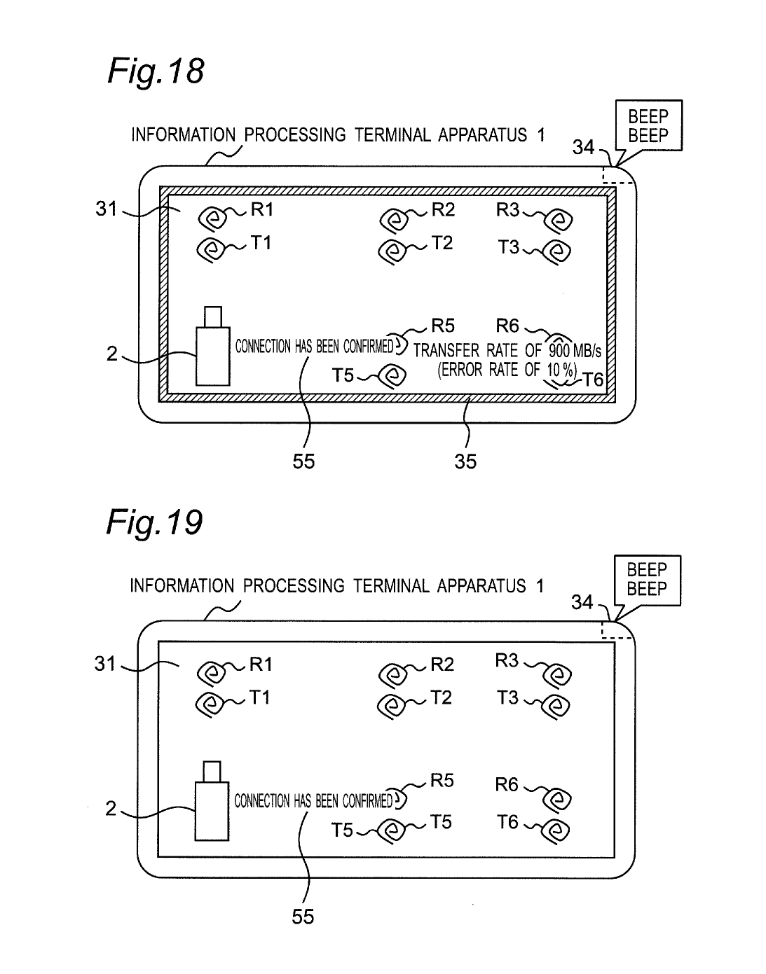

FIG. 17 is a timing chart showing operation of the communication system of FIG. 1 according to a third embodiment of the present disclosure. As compared with the timing chart of FIG. 6, the timing chart of FIG. 17 is configured to include a position adjustment completion notice process of step S17A instead of step S17 of the position adjustment completion notice process. In step S17A, the information processing terminal apparatus 1 controls ones to output a beep sound from the speaker 34, make the light-emitting element 35 emit light, and display the transfer rate and the text message 55 on the liquid crystal panel 31. FIG. 18 is a plan diagram showing the text message 55 displayed on the liquid crystal panel 31, an output state of the beep sound from the speaker 34, a light-emitting state of the light-emitting element 35, and the recording media 2, in step S17A of FIG. 17. Referring to FIG. 18, the light-emitting element 35 is provided at the edge of the liquid crystal panel 31.

According to the present embodiment, the user can acoustically and visually recognize that the antenna T21 is opposed to the data transfer antenna R4, the antenna R21 is opposed to the data transfer antenna T4, and then, it is possible to perform the wireless communication between the information processing terminal apparatus 1 and the recording media 2. Accordingly, it is possible to further improve the operability than that of the first embodiment.

### First Modified Embodiment of the Third Embodiment

FIG. 19 is a plan diagram showing the text message 55 displayed on the liquid crystal panel 31, the output state of the beep sound from the speaker 34, and the recording media 2, in step S17A of FIG. 17 according to a first modified embodiment of the third embodiment of the present disclosure. In the third embodiment, in step S17A of FIG. 17, it is notified by both the speaker 34 and the light-emitting element 35 that it is possible to perform the wireless communication between the information processing terminal apparatus 1 and the recording media 2. However, as illustrated in FIG. 19, without any usage of the light-emitting element 35, it may be notified by only the speaker 34 that it is possible to perform the wireless communication between the information processing terminal apparatus 1 and the recording media 2.

### Second Modified Embodiment of the Third Embodiment

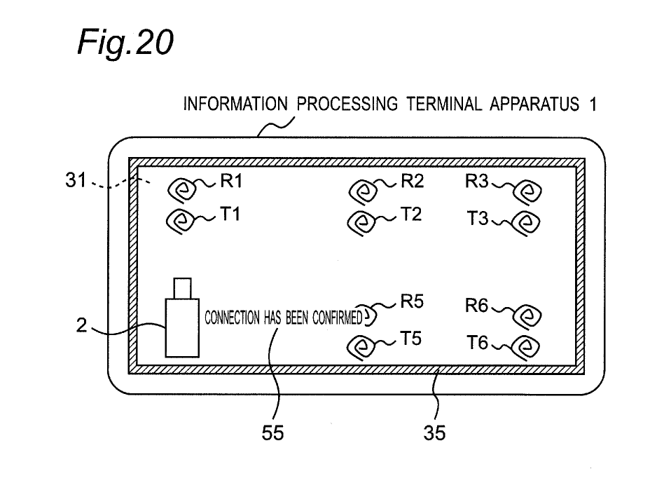

FIG. 20 is a plan diagram showing the text message 55 displayed on the liquid crystal panel 31, the light-emitting state of the light-emitting element 35, and the recording media 2, in step S17A of FIG. 17 according to a second modified embodiment of the third embodiment of the present disclosure. In the third embodiment, in step S17A of FIG. 17, it is notified by both the speaker 34 and the light-emitting element 35 that it is possible to perform the wireless communication between the information processing terminal apparatus 1 and the recording media 2. However, as illustrated in FIG. 20, without any usage of the speaker 34, it may be notified by only the light-emitting element 35 that it is possible to perform the wireless communication between the information processing terminal apparatus 1 and the recording media 2.

### Fourth Embodiment

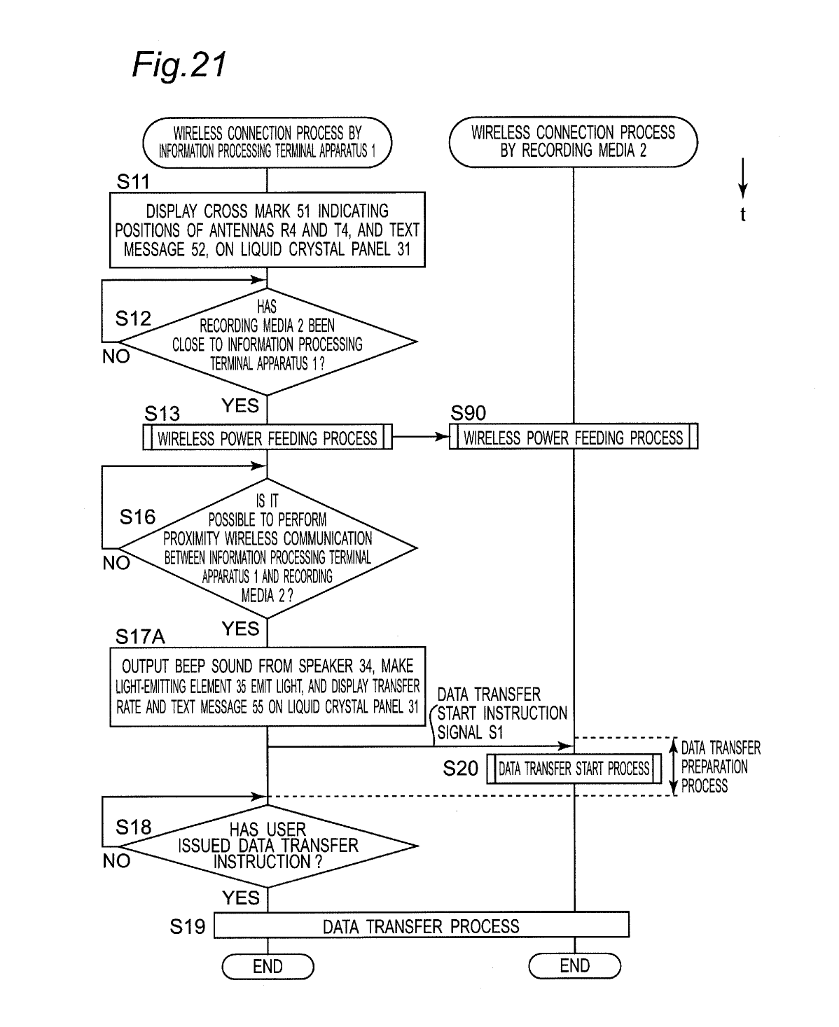

FIG. 21 is a timing chart showing operation of the communication system of FIG. 1 according to a fourth embodiment of the present disclosure. As compared with the timing chart of FIG. 17, the timing chart of FIG. 21 is configured to be omitted the antenna position adjustment process from the timing chart of FIG. 17. In addition, the information processing terminal apparatus 1 selects the antennas R4 and T4 as the data transfer antennas. Referring to FIG. 21, without any reception of the device information signal S2 from the recording media 2, which is followed by the wireless feeding process of step S13, in step S16, the information processing terminal apparatus 1 judges whether or not it is possible to perform the proximity wireless communication between the information processing terminal apparatus 1 and the recording media 2, and if it is YES, the process proceeds to step S17A. On the other hand, if it is NO, the process of step S16 is repeatedly performed.

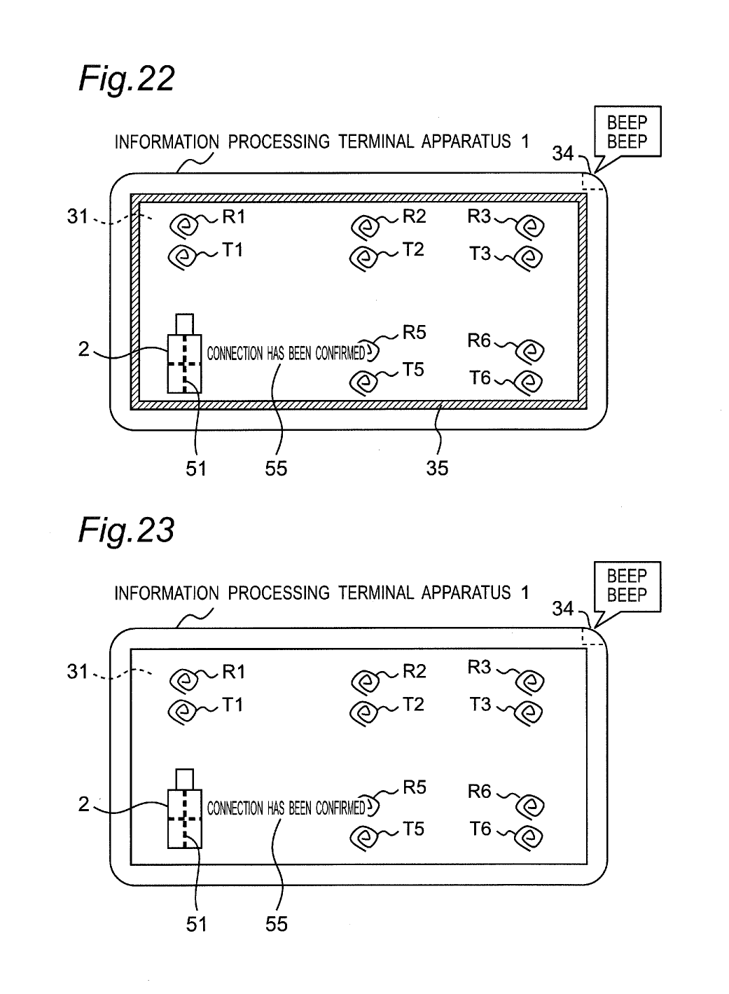

FIG. 22 is a plan diagram showing the cross mark 51 and the text message 55 displayed on the liquid crystal panel 31, an output state of the beep sound from the speaker 34, the light-emitting state of the light-emitting element 35, and the recording media 2, in step S17A of FIG. 17. According to the present embodiment, the mark 53 of the recording media 2 can not be displayed (See FIG. 8), but the cross mark 51 can be displayed. Accordingly, the operability of the present embodiment becomes lower than that of each of the above embodiments. However, it is not necessary for the recording media 2 to transmit the device information signal S2 to the information processing terminal apparatus 1. Accordingly, the configuration of the recording media 2 according to the present embodiment can be more simplified than that of each of the embodiments.

### First Modified Embodiment of the Fourth Embodiment

FIG. 23 is a plan diagram showing the cross mark 51 and the text message 55 displayed on the liquid crystal panel 31, an output state of the beep sound from the speaker 34, and the recording media 2, in step S17A of FIG. 17 according to a first modified embodiment of the fourth embodiment of the present disclosure. In the fourth embodiment, in step S17A of FIG. 21, it is notified by both the speaker 34 and the light-emitting element 35 that it is possible to perform the wireless communication between the information processing terminal apparatus 1 and the recording media 2. However, as illustrated in FIG. 23, without any usage of the light-emitting element 35, it may be notified by only the speaker 34 that it is possible to perform the wireless communication between the information processing terminal apparatus 1 and the recording media 2.

### Second Modified Embodiment of the Fourth Embodiment

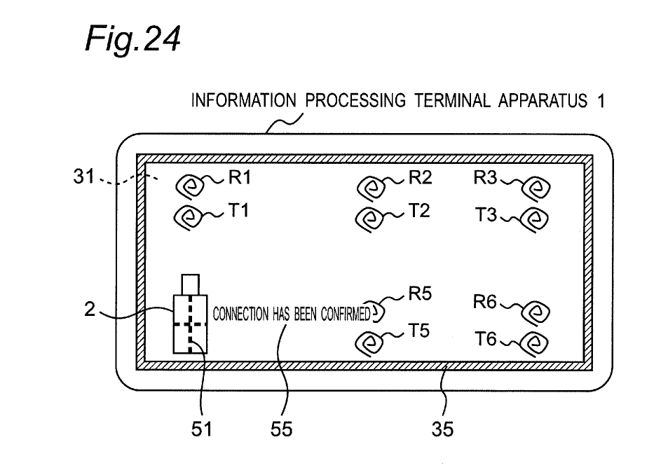

FIG. 24 is a plan diagram showing the cross mark 51 and the text message 55 displayed on the liquid crystal panel 31, the light-emitting state of the light-emitting element 35, and the recording media 2, in step S17A of FIG. 17 according to a second modified embodiment of the fourth embodiment of the present disclosure. In the fourth embodiment, in step S17A of FIG. 21, it is notified by both the speaker 34 and the light-emitting element 35 that it is possible to perform the wireless communication between the information processing terminal apparatus 1 and the recording media 2. However, as illustrated in FIG. 24, without any usage of the speaker 34, it may be notified by only the light-emitting element 35 that it is possible to perform the wireless communication between the information processing terminal apparatus 1 and the recording media 2.

In the third embodiment and the modified embodiments thereof, and the fourth embodiments and the modified embodiments thereof, it is noted that the light-emitting element 35 provided at the edge of the liquid crystal panel 31 emits light. However, the present disclosure is not limited thereto. For example, visual notice means may notify that the wireless communication between the information processing terminal apparatus 1 and the recording media 2. For example, the liquid crystal panel 31 may be allowed to wholly emit light, the color of the liquid crystal panel 31 may be changed, or the edge of the information processing terminal apparatus 1 may be allowed to emit light. In addition, in the present embodiment, the speaker 34 outputs the beep sound. However, the present disclosure is not limited thereto. For example, auditory notice means may notify that it is possible to perform the wireless communication between the information processing terminal apparatus 1 and the recording media 2. For example, the speaker 34 may output music.

### Fifth Embodiment

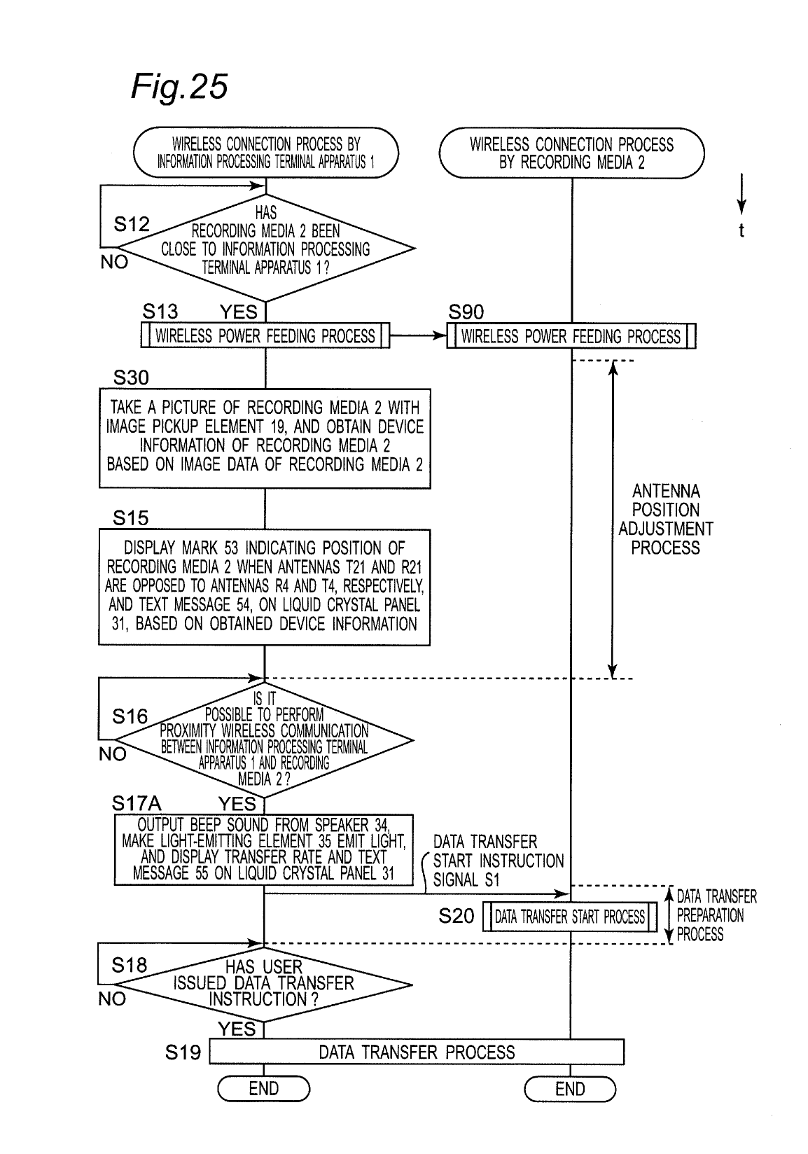

FIG. 25 is a timing chart showing operation of the communication system of FIG. 1 according to a fifth embodiment of the present disclosure. As the timing chart of FIG. 17, the timing chart of FIG. 25 is configured to include a process of step S30 by the information processing terminal apparatus 1 instead of the transmission process of the device information signal S2 by the recording media 2 and the process of step S14 by the information processing terminal apparatus 1. In step S30, the information processing terminal apparatus 1 takes a picture of the recording media 2 using the image pickup element 19, and obtains the device information of the recording media 2 based on image data of the recording media 2. Concretely speaking, a table indicating relations among the image data of the recording media 2, the device shape indicating the shape of the recording media 2, and the antenna positions indicating each of the positions of the antennas T21 and R21 in the recording media 2, is stored in advance in the nonvolatile memory 12 or the storage device on the network. Then, the information processing terminal apparatus 1 obtains the device shape of the recording media 2, and each of the positions of the antennas T21 and R21 with reference to this table based on the image data of the recording media 2.

According to the present embodiment, even when the communication error time period 101 (See FIG. 11) is very long and the information processing terminal apparatus 1 can not normally receive the device information signal S2 from the recording media 2, the information processing terminal apparatus 1 can obtain the device information of the recording media 2.

### Sixth Embodiment

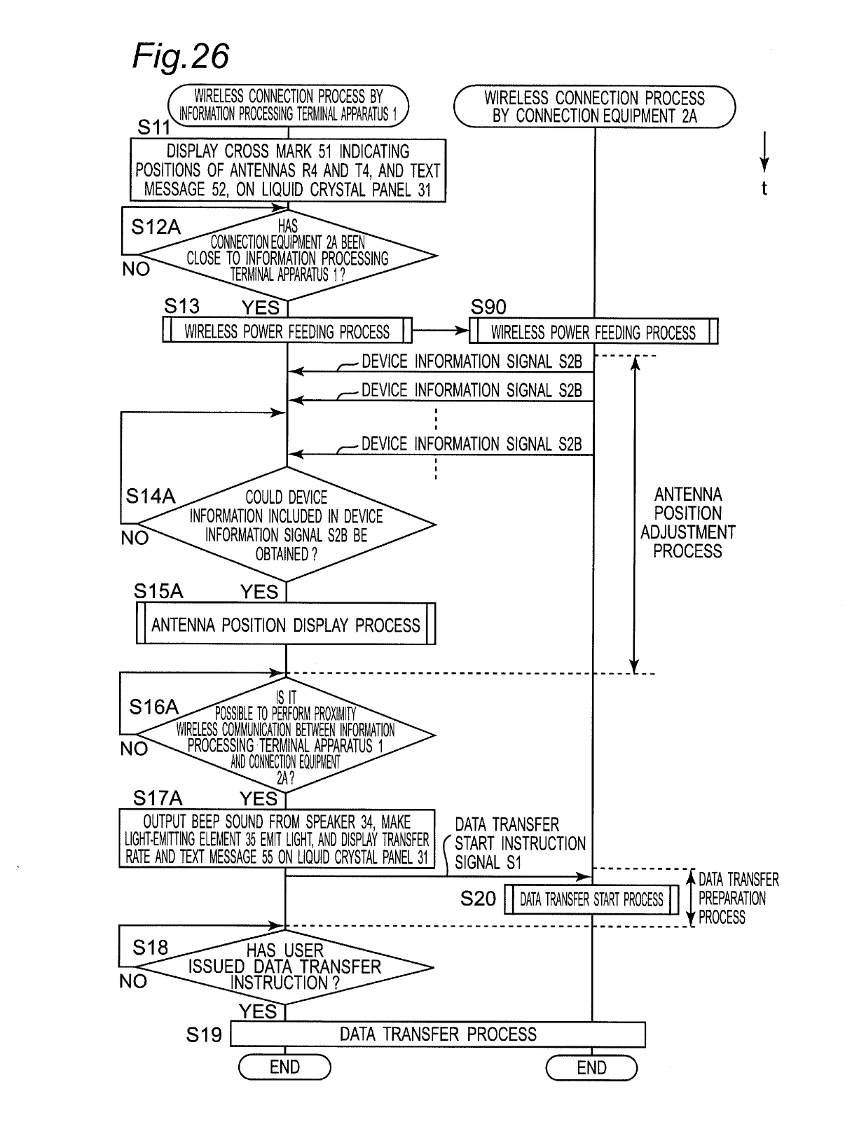

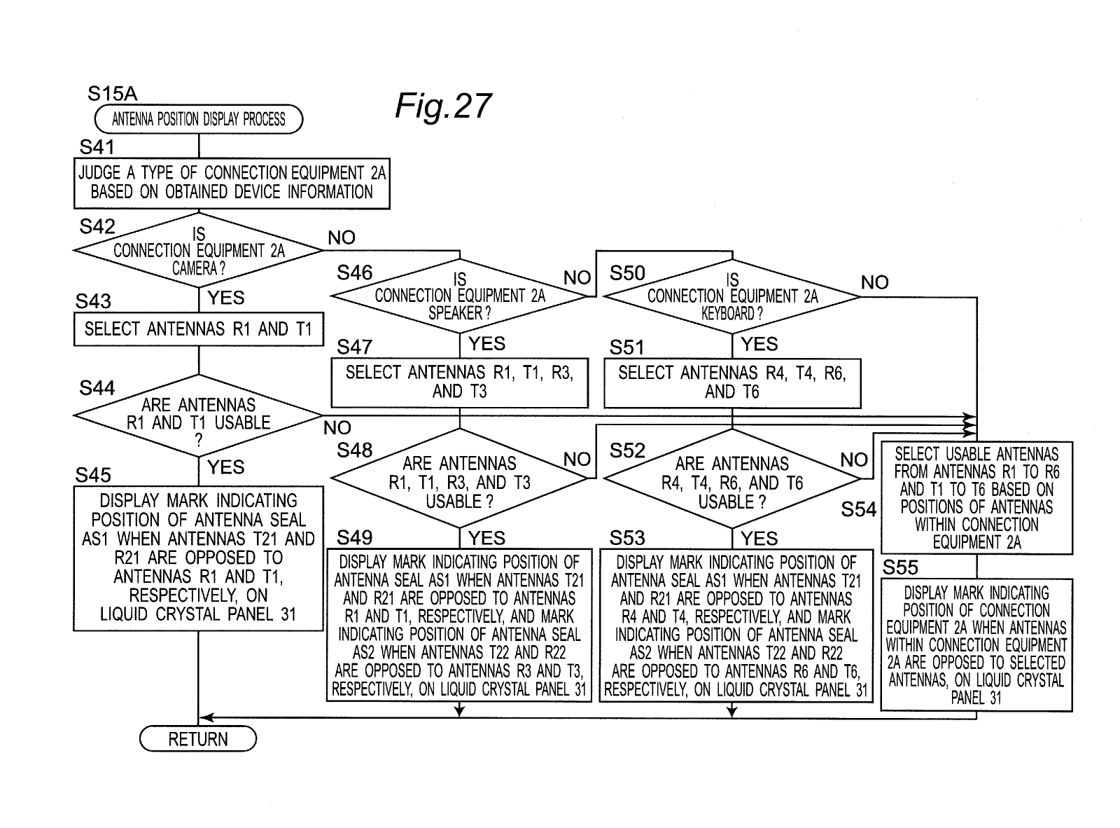

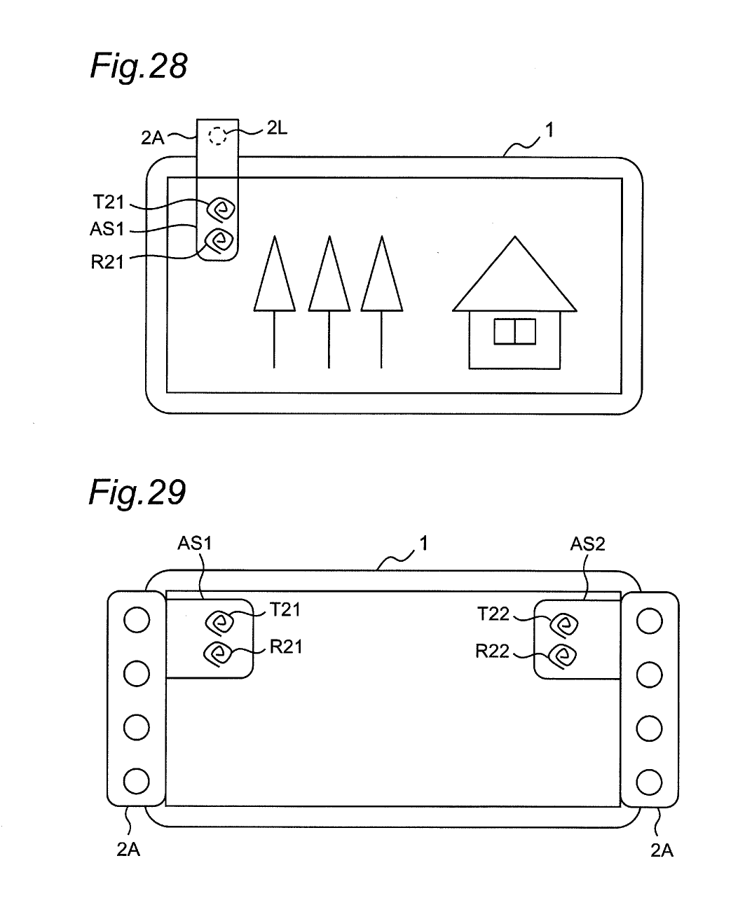

FIG. 26 is a timing chart showing operation of a communication system provided with the information processing terminal apparatus 1 of FIG. 1 and the connection equipment 2A according to a sixth embodiment of the present disclosure. FIG. 27 is a flow chart showing an antenna position display process in step S15A of FIG. 26. In addition, FIG. 28 is a plan diagram showing the information processing terminal apparatus 1 and the connection equipment 2A when it is possible to perform the proximity wireless communication between the information processing terminal apparatus 1 and the connection equipment 2A of a camera, in step S16A of FIG. 26. Further, FIG. 29 is a plan diagram showing the information processing terminal apparatus 1 and the connection equipment 2A when it is possible to perform the proximity wireless communication between the information processing terminal apparatus 1 and the connection equipment 2A of a speaker, in step S16A of FIG. 26. Furthermore, FIG. 30 is a plan diagram showing the information processing terminal apparatus 1 and the connection equipment 2A when it is possible to perform the proximity wireless communication between the information processing terminal apparatus 1 and the connection equipment 2A of a keyboard, in step S16A of FIG. 26.

In the present embodiment, the nonvolatile memory 12 of the information processing terminal apparatus 1 stores in advance the equipment connection application software program for performing the proximity wireless communication between the information processing terminal apparatus 1 and the connection equipment 2A. In this case, the connection equipment 2A is electronic equipment such as a camera, a speaker, a keyboard, and the recording media 2, and the connection equipment 2A is configured to include at least the system control circuit 21 of the recording media 2 of FIG. 2, the nonvolatile memory 22, the proximity wireless communication module 23, and the antennas T21 and R21.

As illustrated in FIG. 28, when the connection equipment 2A is the camera, the antennas T21 and R21 are formed within an antenna seal AS1. In addition, as illustrated in FIG. 29, when the connection equipment 2A is the speaker, the connection equipment 2A is configured to include the antennas T21 and R21 formed within the antenna seal AS1 attached to a left speaker, and antennas T22 and R22 formed within an antenna seal AS2 attached to a right speaker. Further, as illustrated in FIG. 30, when the connection equipment 2A is the keyboard, the connection equipment 2A is configured to include the antennas T21 and R21 formed within the antenna seal AS1 attached at the left top corner of the connection equipment 2A, and the antennas T22 and R22 formed within the antenna seal AS2 attached at the right top corner of the connection equipment 2A. It is noted that the antenna seals AS1 and AS2 are made each of a transparent material attachable onto the protection film 33 (See FIG. 3) of the information processing terminal apparatus 1.

Next, referring to FIGS. 26 and 27, the operation of the communication system provided with the information processing terminal apparatus 1 of FIG. 1 and the connection equipment 2A is described. In addition, in the timing chart of FIG. 26, the main body of the operation of the information processing terminal apparatus 1 is the main processor 11, and the main body of the operation of the connection equipment 2A is the system control circuit 21. However, their descriptions are omitted. When the user performs predetermined operation in the information processing terminal apparatus 1 for activating the equipment connection application software, the information processing terminal apparatus 1 performs the wireless connection process of FIG. 26.

First of all, in step S11 of FIG. 26, the information processing terminal apparatus 1 controls the liquid crystal panel 31 to display the cross mark 51 indicating the positions of the antennas R4 and T4, and the text message 52 such as “please overlap the one antenna seal of the connection equipment on the cross mark” on the liquid crystal panel 31. Then, in step S12A of FIG. 26, when the connection equipment 2A is close to the information processing terminal apparatus 1, the information processing terminal apparatus 1 judges whether or not it is possible to wirelessly feed an electric power to the connection equipment 2A, and if it is YES in step S12A, the process proceeds to step S13. On the other hand, if it is NO, the process of step S12A is repeatedly performed. In step S13, the information processing terminal apparatus 1 performs a predetermined wireless feeding process to transmit the electric power to the connection equipment 2A.

On the other hand, in step S90, the connection equipment 2A performs a predetermined wireless feeding process to receive the electric power from the information processing terminal apparatus 1. When the connection equipment 2A starts to receive the electric power from the information processing terminal apparatus 1, the connection equipment 2A wirelessly transmits the device information signal S2B using the antenna T21 repeatedly at predetermined time intervals. In this case, the device information signal S2B includes an identification code for identifying the connection equipment 2A and the device information. In this case, the device information includes a device shape information indicating the shape of the connection equipment 2A, the antenna position information indicating each of the positions of the antennas of the connection equipment 2A, and information of a type of the connection equipment 2A.

In step S14A of FIG. 26, the information processing terminal apparatus 1 judges whether or not it is possible to obtain the device information included in the device information signal S2B, and if it is YES, the process proceeds to step S15A. On the other hand, if it is NO, the process of step S14A is repeatedly performed. In step S15A, the information processing terminal apparatus 1 performs an antenna position displaying process as described below in FIG. 27. Further, in step S16A, the information processing terminal apparatus 1 judges whether or not it is possible to perform the proximity wireless communication between the information processing terminal apparatus 1 and the connection equipment 2A, and if it is YES, the process proceeds to step S17A. On the other hand, if it is NO, the process of step S16A is repeatedly performed. Concretely speaking, when the communication error rate between the information processing terminal apparatus 1 and the connection equipment 2A is equal to or lower than a predetermined threshold value, the information processing terminal apparatus 1 judges that it is possible to perform the proximity wireless communication between the information processing terminal apparatus 1 and the connection equipment 2A. On the other hand, when the communication error rate is larger than the threshold value, the information processing terminal apparatus 1 judges that it is not possible to perform the proximity wireless communication between the information processing terminal apparatus 1 and the connection equipment 2A. The process of step S17A and thereafter is the same as that of step S17A and thereafter of FIG. 17. Accordingly, their descriptions are omitted.

Then, the antenna position displaying process of FIG. 27 is described. First of all, in step S41, the information processing terminal apparatus 1 judges the type of the connection equipment 2A based on the obtained device information, and proceeds to step S42. In step S42, the information processing terminal apparatus 1 judges whether or not the connection equipment 2A is the camera, and if it is YES, the process proceeds to step S43. On the other hand, if it is NO, the process proceeds to step S46. In step S43, the information processing terminal apparatus 1 selects the antennas R1 and T1 as the data transfer antennas, in step S44, the information processing terminal apparatus 1 judges whether or not it is possible to use the antennas R1 and T1, and if it is YES, the process proceeds to step S45. On the other hand, if it is NO, the process proceeds to step S54. In step S45, the information processing terminal apparatus 1 displays a mark indicating the position of the antenna seal AS1 when the antennas T21 and R21 are opposed to the antennas R1 and T1, respectively, on the liquid crystal panel 31, and the process returns to the wireless connection process of FIG. 26.

In addition, in step S46, the information processing terminal apparatus 1 judges whether or not the connection equipment 2A is the speaker, and if it is YES, the process proceeds to step S47. On the other hand, if it is NO, the process proceeds to step S50. In step S47, the information processing terminal apparatus 1 selects the antennas R1, T1, R3, and T3 as the data transfer antennas, and in step S48, the information processing terminal apparatus 1 judges whether or not it is possible to use the antennas R1, T1, R3, and T3. Then, if it is YES in step S48, the process proceeds to step S49. On the other hand, if it is NO, the process proceeds to step S54. In step S49, the information processing terminal apparatus 1 displays the mark indicating the position of the antenna seal AS1 when the antennas T21 and R21 are opposed to the antennas R1 and T1, respectively, and a mark indicating a position of the antenna seal AS2 when the antennas T22 and R22 are opposed to antennas R3 and T3, respectively, on the liquid crystal panel 31, and the process returns to the wireless connection process of FIG. 26.

Further, in step S50, the information processing terminal apparatus 1 judges whether or not the connection equipment 2A is the keyboard, and if it is YES, the process proceeds to step S51. On the other hand, if it is NO, the process proceeds to step S54. In step S51, the information processing terminal apparatus 1 selects the antennas R4, T4, R6, and T6 as the data transfer antennas, and in step S52, the information processing terminal apparatus 1 judges whether or not it is possible to use the antennas R4, T4, R6, and T6. Then, if it is YES in step S52, the process proceeds to step S53. On the other hand, if it is NO, the process proceeds to step S54. In step S53, the information processing terminal apparatus 1 displays the mark indicating the position of the antenna seal AS1 when the antennas T21 and R21 are opposed to the antennas R4 and T4, respectively, and the mark indicating the position of the antenna seal AS2 when the antennas T22 and R22 are opposed to the antennas R6 and T6, respectively, on the liquid crystal panel 31, and the process returns to the wireless connection process of FIG. 26.

Furthermore, In step S54, the information processing terminal apparatus 1 selects useable antennas of the antennas R1 to R6 and T1 to T6 as the data transfer antennas based on the positions of the antennas within the connection equipment 2A. Then, in step S55, the information processing terminal apparatus 1 displays a mark indicating the position within the connection equipment 2A when the antennas within the connection equipment 2A are opposed to the selected antennas on the liquid crystal panel 31, and the process returns to the wireless connection process of FIG. 26.

According to the present embodiment, as illustrated in FIG. 28, when the connection equipment 2A is a camera, the antennas R1 and T1 located in the left top of the information processing terminal apparatus 1 are selected, and are wirelessly connected to the antennas T21 and R21 of the connection equipment 2A. Accordingly, a camera lens 2L provided on the back of the connection equipment 2A can not be hidden by the information processing terminal apparatus 1. In addition, as illustrated in FIG. 29, when the connection equipment 2A is the speaker 34, the antennas R1 and T1 located in the left top of the information processing terminal apparatus 1 and the antennas R3 and T3 located in the right top of the information processing terminal apparatus 1 are selected, and therefore, the antennas R1 and T1 are wirelessly connected to the antennas T21 and R21 and the antennas R3 and T3 are wirelessly connected to the antennas T22 and R22. Accordingly, when the connection equipment 2A outputs a voice data from the information processing terminal apparatus 1, the information processing terminal apparatus 1 can make sound outputted from the speaker spread.

Further, as illustrated in FIG. 30, when the connection equipment 2A is a keyboard, the antennas R4 and T4 located in the left bottom of the information processing terminal apparatus 1 and the antennas R6 and T4 located in the right bottom of the information processing terminal apparatus 1 are selected, and therefore, the antennas R4 and T4 are wirelessly connected to the antennas T21 and R21, and the antennas R6 and T6 are wirelessly connected to the antennas T22 and R22. Accordingly, the user can use the information processing terminal apparatus 1 and the connection equipment 2A like one laptop-type personal computer.

As described above, according to the present embodiment, it is possible to further improve the operability than that of each of the embodiments.

In addition, in the present embodiment, the information processing terminal apparatus 1 feeds the electric power to the connection equipment 2A. However, the present disclosure is not limited thereto. For example, when the connection equipment 2A has a power supply, the information processing terminal apparatus 1 needs not to feed to the connection equipment 2A.

### Modified Embodiment of the Sixth Embodiment

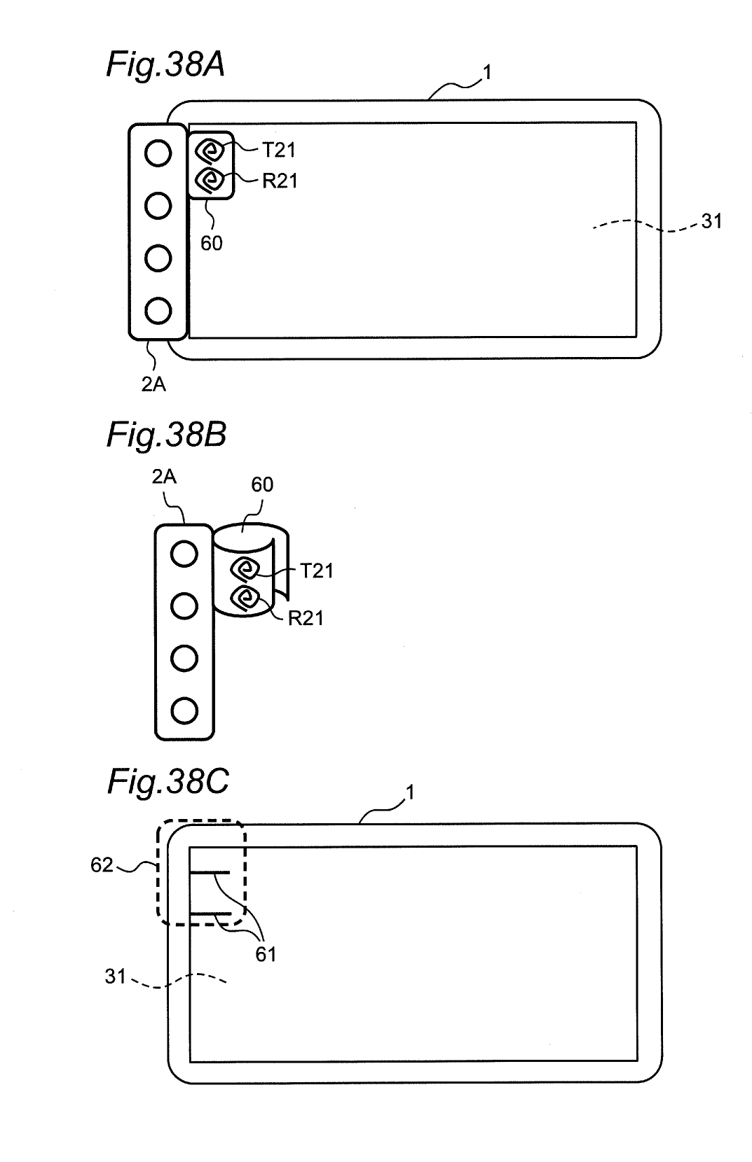

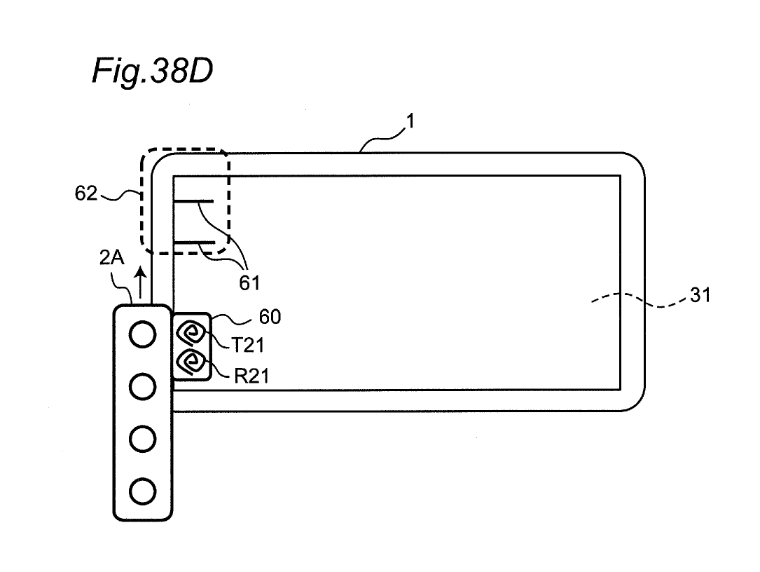

FIG. 38A is a plan diagram showing the connection equipment 2A of the speaker of FIG. 29 according to the modified embodiment of the sixth embodiment of the present disclosure. FIG. 38B is a perspective diagram showing a structure of a clip 60 of the connection equipment 2A of FIG. 38A. In the above sixth embodiment, the connection equipment 2A of FIG. 29 is provided with the antenna seal AS1 forming the antennas T21 and R21 therein. However, as illustrated in FIGS. 38A and 38B, the connection equipment 2A is provided with the clip 60 in which the antennas T21 and R21 are formed, instead of the antenna seal AS1. In this case, such operation that the information processing terminal apparatus 1 is pinched by the clip 60 of the connection equipment 2A is described below.

FIG. 38C is a plan diagram showing a guide 61 indicating a position where the information processing terminal apparatus 1 is pinched by the clip 60 of the connection equipment 2A of FIG. 38A. FIG. 38D is a plan diagram showing a state when the information processing terminal apparatus 1 is pinched by the clip 60 using the guide 61 of FIG. 38C. Referring to FIG. 38C, when the connection equipment 2A of the speaker is mounted on the information processing terminal apparatus 1, the clip guide 61 is displayed within a predetermined area 62 on the liquid crystal panel 31, for example, based on operations from the outside. Then, as illustrated in FIG. 38D, the connection equipment 2A moves in the direction of the arrow from the bottom of the information processing terminal apparatus 1 until the clip 60 enters the clip guide 61, and the mounting process of the connection equipment 2A on the information processing terminal apparatus 1 is completed.

### Seventh Embodiment

FIG. 31 is a plan diagram showing a configuration of an information processing terminal apparatus 1A according to a seventh embodiment of the present disclosure. FIG. 32 is a plan diagram showing the information processing terminal apparatus 1A of FIG. 31, a mark 56 displayed on the liquid crystal panel 31, and a connection equipment 2B. As compared with the information processing terminal apparatus 1 according to each of the above embodiments, there is such a difference that the information processing terminal apparatus 1A is configured to include transmitting and receiving antenna coils RT1 to RT 4 instead of the antennas R1 to R6 and T1 to T6. The differences between the present embodiment and each of the above embodiments are described below.

Referring to FIG. 31, each distance D1 of a center of each side of the liquid crystal panel 31 to a center of each of the antennas RT1 to RT4 is predetermined based on a predetermined standard. In addition, the connection equipment 2B is configured to include an antenna RT21 of the transmitting and receiving antenna coil. In this case, a position of the antenna RT21 is set so that a distance of the center of the antenna RT21 to the edge of the liquid crystal panel 31 is set to be the distance D1 when the bottom side of the connection equipment 2B is positioned on the edge of the information processing terminal apparatus 1. Accordingly, according to the present embodiment, for example, as illustrated in FIG. 32, the mark 53 of the recording media 2 of FIG. 8 is simplified as the dashed mark 56 indicating the longitudinal direction of the connection equipment 2B.

### Eighth Embodiment

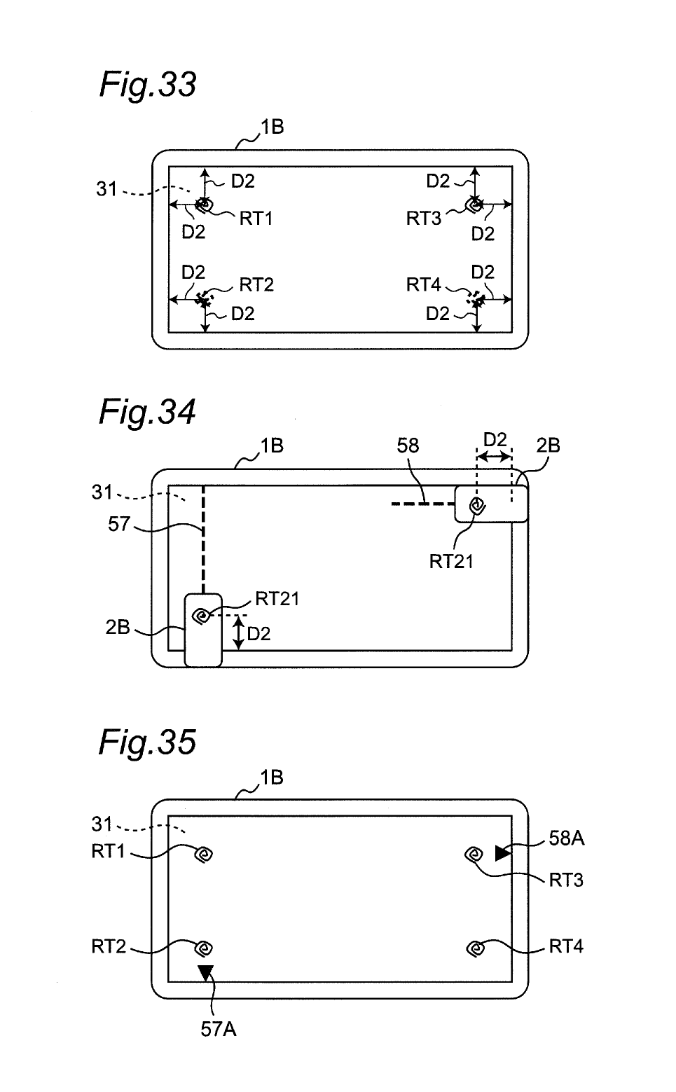

FIG. 33 is a plan diagram showing a configuration of an information processing terminal apparatus 1B according to an eighth embodiment of the present disclosure, and FIG. 34 is a block diagram showing the information processing terminal apparatus 1B of FIG. 33, marks 57 and 58 displayed on the liquid crystal panel 31, and the connection equipment 2B. As compared with the information processing terminal apparatus 1A according to the seventh embodiment, there is such a difference that the positions of the antennas RT1 to RT4 of the information processing terminal apparatus 1B according to the present embodiment are different from those of the antennas RT1 to RT4 of the information processing terminal apparatus 1A according to the seventh embodiment. Only the differences between the present embodiment and the seventh embodiment are described below.

Referring to FIG. 33, a distance D2 of a center of each of the antennas RT1 to RT 4 to each side of the liquid crystal panel 31 is predetermined by a predetermined standard so that the distances of centers of the antennas RT1 to RT4 to corners of the liquid crystal panel 31 are equal to each other. In addition, the position of the antenna RT21 of the connection equipment 2B is set so that the distance of the center of the antenna RT21 to the edge of the liquid crystal panel 31 is set to be the distance D2 when the bottom side of the connection equipment 2B is positioned on the edge of the information processing terminal apparatus 1A. Accordingly, according to the present embodiment, for example, as illustrated in FIG. 34, the mark 53 of the recording media 2 of FIG. 8 is simplified as the dashed mark 56 or 57 indicating the longitudinal direction of the connection equipment 2B.

FIG. 35 is a plan diagram showing the information processing terminal apparatus 1B of FIG. 33, other marks 57A and 58A displayed on the liquid crystal panel 31, and the connection equipment 2B. Triangular marks 57A and 58A instead of the mark 56 or 57 of FIG. 34 may be displayed at the edge of the liquid crystal panel 31.

### Ninth Embodiment

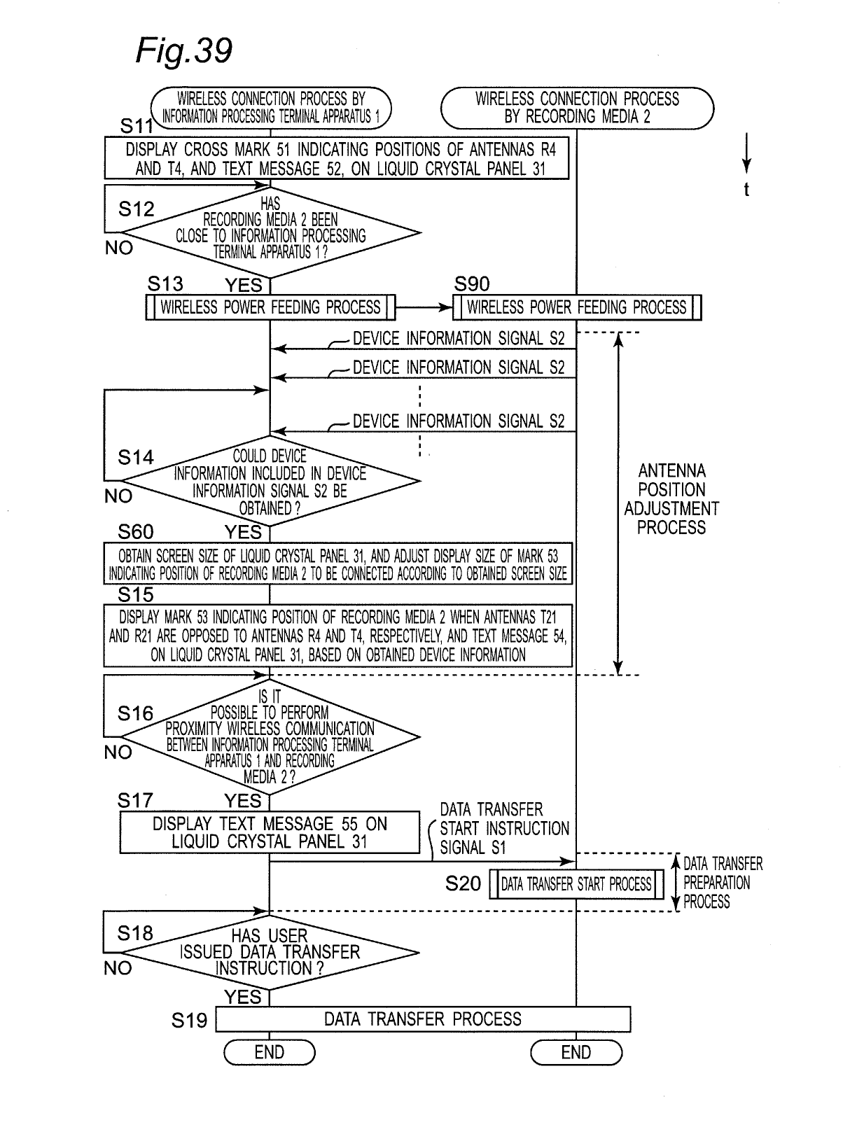

FIG. 39 is a timing chart showing operation of the communication system of FIG. 1 according to a ninth embodiment of the present disclosure. As compared with the timing chart of FIG. 6, the timing chart of FIG. 39 is characterized in that step S60 for adjusting a displaying size of the mark 53 is further included after step S14. In step S60 of FIG. 36, the information processing terminal apparatus 1 obtains a screen size of the liquid crystal panel 31 of the information processing terminal apparatus 1 from the device information included in the device information signal S2 in step S14, and adjusting the displaying size of the mark 53 indicating the positions of the connection equipment such as the recording media 2 to be connected according to the screen size by using a table such as a table as illustrated in FIG. 38A as described below. That is, a function of performing a scaling process of the mark 53 displayed on the liquid crystal panel 31 according to the screen size of the liquid crystal panel 31 of the information processing terminal apparatus 1 is incorporated in the information processing terminal apparatus 1. In this case, the main processor 11 (control means) of FIG. 2 may have the function. The scaling process is described below.

In step S60 of FIG. 39, the information processing terminal apparatus 1 obtains the size information of the recording media 2 such as the USB memory (for example, included in the device information signal S2 of FIG. 10, etc.) by using the proximity wireless communication. For example, when the recording media 2 such as the USB memory having a square shape of 1 inch by 1 inch is displayed to be equal to a pixel density of 300 ppi of the liquid crystal panel 31, the number of drawing pixels is set to be 300 pixels (=300 ppi by 1 inch). Accordingly, it is possible to draw the square of 300 pixels by 300 pixels and display the mark 53 having a real size of the recording media 2 such as the USB memory. However, it is not possible to display this recording media 2 on the liquid crystal panel 31 having a screen size of 200 pixels by 200 pixels.

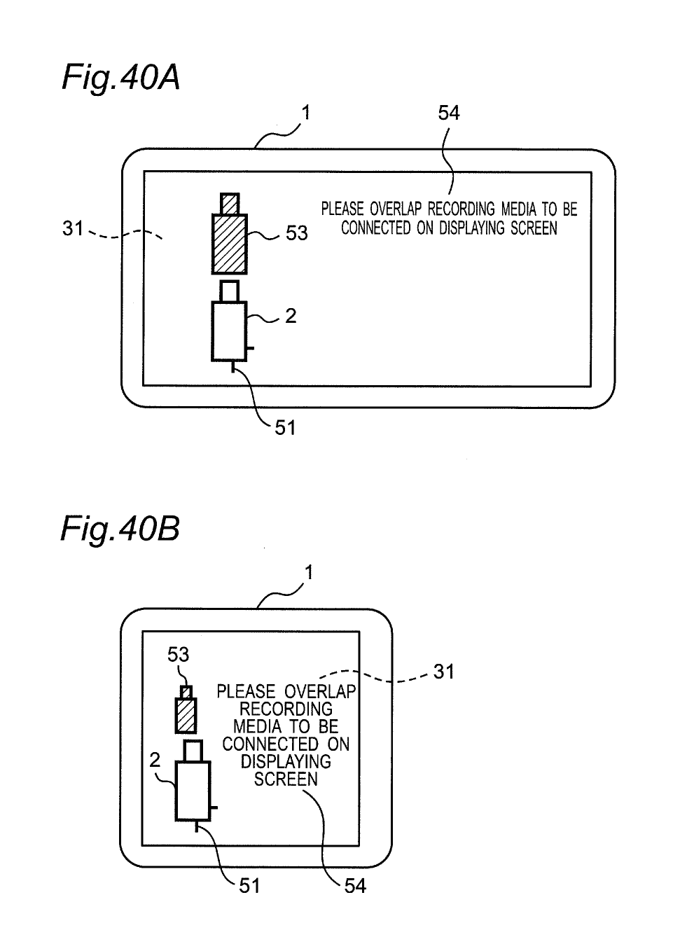

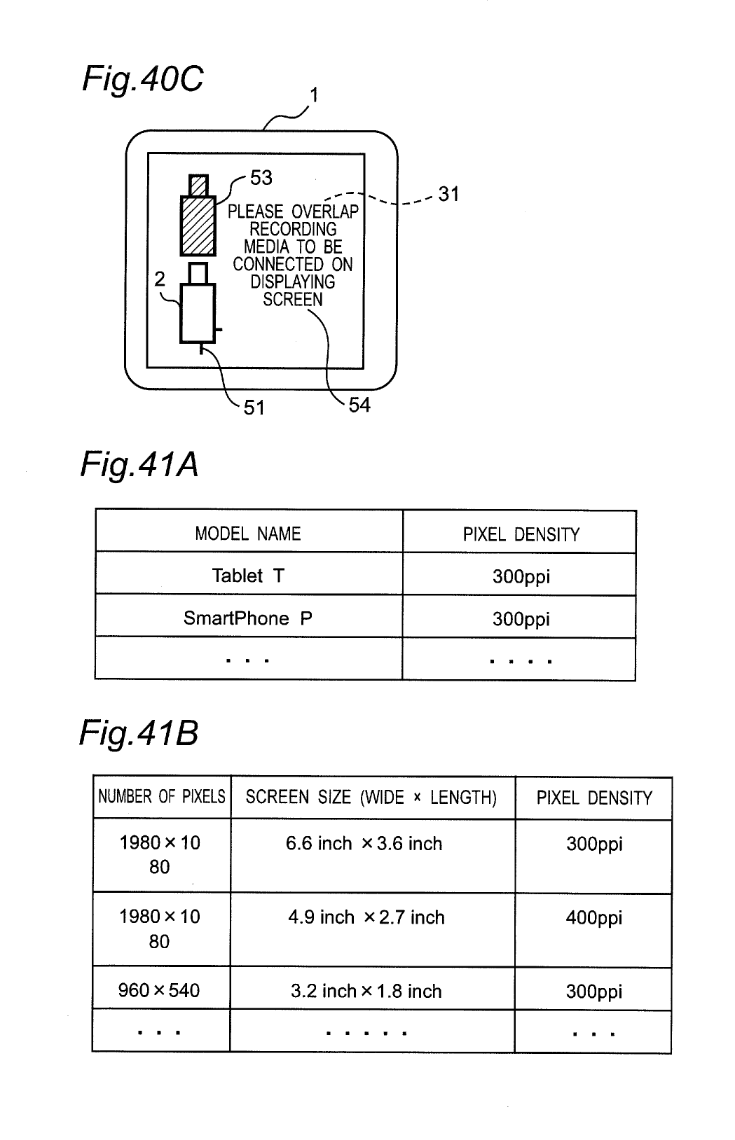

FIG. 40A is a plan diagram showing the mark 53 displayed on the liquid crystal panel 31 having a large screen size and the recording media 2, in step S15A of FIG. 14, and FIG. 40B is a plan diagram showing the mark 53 displayed on the liquid crystal panel 31 having a small screen size and the recording media 2, in step S15A of FIG. 14. Referring to FIGS. 40A and 40B, when the mark 53 is displayed on the liquid crystal panel 31 of the information processing terminal apparatus 1 having a small screen size, the mark 53 is scaled according to a small screen size and is displayed with the size smaller than the real size of the recording media 2 such as the USB memory by using the same drawing data as the drawing data when the mark 53 is displayed on the liquid crystal panel 31 of the information processing terminal apparatus 1 having a large screen size. Accordingly, the mark 53, which is scaled according to the screen size of the liquid crystal panel 31 to be displayed, is not effective as a superposition guide.

FIG. 40C is a plan diagram showing the mark 53 displayed on the liquid crystal panel 31 having a small screen size and the recording media 2, in step S15 of FIG. 36. As compared with FIG. 40B, the displaying size of the mark 53 of FIG. 40C can not be scaled to be reduced according to the screen size of the liquid crystal panel 31. Accordingly, the mark 53 is effective as a guide for overlapping the recording media 2 thereon.

FIG. 41A is one table for using when a display size of the mark 53 is adjusted according to a screen size of the liquid crystal panel 31, in step S60 of FIG. 36. Referring to FIG. 41A, in order to obtain the pixel density of the liquid crystal panel 31 of the information processing terminal apparatus 1, the information processing terminal apparatus 1 transforms a cited model name of the information processing terminal apparatus 1 (for example, “Tablet T”, etc.) to the pixel density using the application programming interface (API) of OS (basic software) installed in the information processing terminal apparatus 1. Concretely speaking, the model number of “P-03D” represented by the model name of “Tablet T” is cited, and the cited model name is transformed to the pixel density of the liquid crystal panel 31.

In addition, in the present embodiment, the scaling process function is incorporated into the information processing terminal apparatus 1. However, the present disclosure is not limited thereto. For example, the recording media 2 such as the USB memory may transmit the drawing size every the screen size, and the recording media 2 may transmit the drawing data by establishing the communication between the recording media 2 and the information processing terminal apparatus 1 and transmitting the information on the screen size from the information processing terminal apparatus 1 to the recording media 2.

Further, in the present embodiment, the scaling process is performed according to the pixel density of the liquid crystal panel 31. However, the present disclosure is not limited thereto. The scaling process may be performed according to the screen size of the liquid crystal panel 31. For example, when a tablet having a screen size of 5 inch by 7 inch is connected to a peripheral equipment having a size of 2.5 inch by 3.5 inch, 2.5 inch divided by 5 inch is equal to ½, and 3.5 inch divided by 7 inch is equal to ½. Accordingly, when a figure having a size of one-half of the screen size of the tablet is illustrated, it is possible to draw the mark 53 having the same size as that of the real peripheral equipment. Concretely speaking, the mark 53 for placing the peripheral equipment is displayed so that the position of the antenna (for example, the antennas R1 and T1 of FIG. 1, etc.) is centered.

Furthermore, in the present embodiment, the displaying size of the mark 53 is adjusted by using the table of FIG. 41A. However, the present disclosure is not limited thereto. For example, the displaying size of the mark 53 may be adjusted by using a table of FIG. 41B as described below.

FIG. 41B is another table for using when a display size of the mark 53 is adjusted according to a screen size of the liquid crystal panel 31, in step S60 of FIG. 36. Referring to FIG. 41A, in order to obtain the pixel density of the liquid crystal panel 31 of the information processing terminal apparatus 1, the information processing terminal apparatus 1 transforms a cited number of pixels and screen size of the information processing terminal apparatus 1 to the pixel density using the application programming interface (API) of OS (basic software) installed in the information processing terminal apparatus 1. In this case, a relational equation of the number of pixels=the screen size×the pixel density is utilized.

In addition, in each of the above embodiments and the modified embodiments, the information processing terminal apparatus 1, 1A, and 1B are the tablet terminals. However, the present disclosure is not limited thereto. The information processing terminal apparatus 1, 1A, and 1B may be an information processing terminal apparatus having a wireless communication function such as a smartphone, a television broadcast receiving device, a recorder, a music player, and a personal computer. In addition, in each of the above embodiments and the modified embodiments, the information processing terminal apparatus 1, 1A, or 1B is connected to the recording media 2, or the connection equipment 2A or 2B. However, the present disclosure is not limited thereto. The information processing terminal apparatus 1, 1A, or 1B may be wirelessly connected to a connection equipment having a wireless communication function such as a USB connector, a power supply connector, a semiconductor integrated circuit chip, or a circuit substrate.

In the first to sixth embodiments and the modified embodiments, the six pairs of antennas R1 to R6 and T1 to T6 are located as illustrated in FIG. 1. However, the present disclosure is not limited thereto. At least one pair of transmission antenna and receiving antenna, or at least one transmitting and receiving antenna may be formed on the surface of the liquid crystal panel 31.

Further, in each of the above embodiments, the information processing terminal apparatus 1, 1A, or 1B is provided with the liquid crystal panel 31. However, the present disclosure is not limited thereto. The other displaying means such as a plasma display panel may be provided with.

As described above, according to the information processing terminal apparatus of the first aspect of the present disclosure, the information processing terminal apparatus performs a proximity wireless communication with a connection equipment comprising a first antenna. The information processing terminal apparatus includes displaying means configured to display predetermined information, at least one second antenna formed of a transparent conductive film on a front surface of the displaying means, and control means configure to select a data transfer antenna from the at least one second antenna, and perform the proximity wireless communication between the first antenna and the data transfer antenna when the first antenna is opposed to the data transfer antenna.

Accordingly, it is possible to provide the information processing terminal apparatus smaller and thinner than that of the prior art, and realizing the waterproof property and the designability higher than that of the prior art.

According to the information processing terminal apparatus of the second aspect, in the information processing terminal apparatus according to the first aspect, the control means controls the displaying means to display a position of the data transfer antenna on the displaying means.

Accordingly, the user can make the first antenna of the connection equipment oppose to the data transfer antenna of the information processing terminal apparatus with reference to the position of the data transfer antenna displayed on the displaying means. Therefore, it is possible to provide the information processing terminal apparatus having the operability higher than that of the prior art.

According to the information processing terminal apparatus of the third aspect, in the information processing terminal apparatus according to the first or second aspect, the control means controls the displaying means to display a position of the connection equipment on the displaying means when the first antenna is opposed to the data transfer antenna.

Accordingly, the user can make the first antenna oppose to the data transfer antenna of the information processing terminal apparatus by placing the connection equipment on the position of the connection equipment displayed on the displaying means, not depending on the shape of the connection equipment. Therefore, it is possible to provide the information processing terminal apparatus having the operability higher than that of the information processing terminal apparatus according to the second aspect.

According to the information processing terminal apparatus of the fourth aspect, in the information processing terminal apparatus according to the third aspect, the control means obtains device information including position information of the first antenna in the connection equipment and shape information of the connection equipment, and controls the displaying means to display the position of the connection equipment on the displaying means based on the obtained device information.

Accordingly, the user can make the first antenna oppose to the data transfer antenna of the information processing terminal apparatus by placing the connection equipment on the position of the connection equipment displayed on the displaying means, not depending on the shape of the connection equipment. Therefore, it is possible to provide the information processing terminal apparatus having the operability higher than that of the information processing terminal apparatus according to the second aspect.

According to the information processing terminal apparatus of the fifth aspect, in the information processing terminal apparatus according to the fourth aspect, the device information further includes type information of the connection equipment, and the control means selects the data transfer antenna based on a type of the connection equipment.

Accordingly, for example, the user can select the second antenna, which is most easiest to operate the connection equipment, as the data transfer antenna according to the type of the connection equipment. Therefore, it is possible to provide the information processing terminal apparatus having the operability higher than that of the information processing terminal apparatuses according to the third and fourth aspects.

According to the information processing terminal apparatus of the sixth aspect, in the information processing terminal apparatus according to the fourth or fifth aspect, the control means wirelessly receives and obtains the device information via one antenna of the at least one second antenna from the connection equipment.

Accordingly, the information processing terminal apparatus can wirelessly receive the device information from the connection equipment.

According to the information processing terminal apparatus of the seventh aspect, in the information processing terminal apparatus according to the fourth or fifth aspect, the information processing terminal apparatus further includes an image pickup element, and the control means obtains the device information based on an image of the connection equipment taken a picture by the image pickup element.

Accordingly, the information processing terminal apparatus can obtain the device information even when the information processing terminal apparatus can not wirelessly receive the device information from the connection equipment.

According to the information processing terminal apparatus of the eighth aspect, in the information processing terminal apparatuses according to the third to seventh aspects, the control means scales a mark of the connection equipment according to a screen size of the displaying means, and controls the displaying means to display the scaled mark of the connection equipment on the displaying means.

According to the information processing terminal apparatus of the ninth aspect, in the information processing terminal apparatuses according to the first to eighth aspects, the control means selects the data transfer antenna so that a mark of the connection equipment does not overlap an image displayed on the displaying means.

According to the information processing terminal apparatus of the tenth aspect, in the information processing terminal apparatuses according to the first to ninth aspects, the control means selects the data transfer antenna so that a mark of the connection equipment is displayed at an edge of the displaying means.

According to the information processing terminal apparatus of the eleventh aspect, in the information processing terminal apparatuses according to the first to tenth aspects, the information processing terminal apparatus further includes notice means configured to notify that the first antenna is opposed to the data transfer antenna.

Accordingly, the user can recognize that it is possible to perform the proximity wireless communication between the connection equipment and the information processing terminal apparatus when the first antenna is opposed to the data transfer antenna.

According to the information processing terminal apparatus of the twelfth aspect, in the information processing terminal apparatus according to the eleventh aspect, the notice means includes at least one of visual notice means and auditory notice means.

Accordingly, the user can visually and/or auditorily recognize that it is possible to perform the proximity wireless communication between the connection equipment and the information processing terminal apparatus when the first antenna is opposed to the data transfer antenna.

According to the information processing terminal apparatus of the thirteenth aspect, the connection equipment performs a proximity wireless communication with an information processing terminal apparatus. The connection equipment includes a first antenna. The information processing terminal apparatus includes displaying means configured to display predetermined information, at least one second antenna formed of a transparent conductive film on a front surface of the displaying means, and control means configured to select a data transfer antenna from the at least one second antenna, and perform the proximity wireless communication between the first antenna and the data transfer antenna when the first antenna is opposed to the data transfer antenna.

Accordingly, it is possible to provide the connection equipment connected to the information processing terminal apparatus smaller and thinner than that of the prior art, and realizing the waterproof property and the designability higher than that of the prior art.

According to the connection equipment of the fourteenth aspect, in the connection equipment according to the thirteenth aspect, the connection equipment wirelessly transmits device information including position information of the first antenna at the connection equipment and shape information of the connection equipment to the information processing terminal apparatus.

Accordingly, the information processing terminal apparatus can display the position of the connection equipment when the first antenna is opposed to the data transfer antenna, on the displaying means, based on the device information from the connection equipment.

According to the connection equipment of the fifteenth aspect, in the connection equipment according to the fourteenth aspect, the device information further includes type information of the connection equipment.

Accordingly, the information processing terminal apparatus can select data transfer antenna based on the type of the connection equipment.

According to the communication system of the sixteenth aspect, the communication system is provided with the information processing terminal apparatus according to the first aspect and the connection equipment according to the thirteenth aspect.

Accordingly, it is possible to provide the communication system provided with the information processing terminal apparatus smaller and thinner than that of the prior art, and realizing the waterproof property and the designability higher than that of the prior art.

According to the communication method for a communication system of the seventeenth aspect, a communication method for a communication system including an information processing terminal apparatus and a connection equipment configured to perform a proximity wireless communication with the information processing terminal apparatus includes the step of selecting a data transfer antenna from the at least one second antenna, and performing the proximity wireless communication between the first antenna and the data transfer antenna when the first antenna is opposed to the data transfer antenna, by the information processing terminal apparatus. The connection equipment includes a first antenna, and the information processing terminal apparatus includes displaying means configured to display predetermined information and at least one second antenna formed of a transparent conductive film on a front surface of the displaying means.

Accordingly, it is possible to provide the communication method for the communication system provided with the information processing terminal apparatus smaller and thinner than that of the prior art, and realizing the waterproof property and the designability higher than that of the prior art.

### REFERENCE SIGNS LIST

1, 1A, 1B Information processing terminal apparatus,
2 Recording media,
2A, 2B Connection equipment,
R1 to R6, T1 to T6, T21, R21, T22, R22, RT1 to RT4 Antenna,
11 Main processor,
12 Nonvolatile memory,
13 Main storage device,
14 Panel driver,
15 Gyro sensor,
16 Touch sensor,
17 Baseband processor,
18-1 to 18-6 Proximity wireless communication module,
19 Image pickup element,
21 System control circuit,
22 Nonvolatile memory,
23 Proximity wireless communication module,
24 Power supply circuit,
31 Liquid crystal panel,
32 Touch panel,
34 Speaker,
35 Light-emitting element,
60 Clip,
61 Clip guide,
62 Area,
300 Image, and
400 Drawing space.

1-17. (canceled)

18. An information processing terminal apparatus configured to perform a proximity wireless communication with a connection equipment comprising a first antenna, the information processing terminal apparatus comprising:
a displaying device configured to display predetermined information,
at least one second antenna formed of a transparent conductive film on a front surface of the displaying device, and
a controller configured to select a data transfer antenna from the at least one second antenna, and perform the proximity wireless communication between the first antenna and the data transfer antenna when the first antenna is opposed to the data transfer antenna.

19. The information processing terminal apparatus as claimed in claim 18,
wherein the controller controls the displaying device to display a position of the data transfer antenna on the displaying device.

20. The information processing terminal apparatus as claimed in claim 18,
wherein the controller controls the displaying device to display a position of the connection equipment on the displaying device when the first antenna is opposed to the data transfer antenna.

21. The information processing terminal apparatus as claimed in claim 20,
wherein the controller obtains device information including position information of the first antenna in the connection equipment and shape information of the connection equipment, and controls the displaying device to display the position of the connection equipment on the displaying device based on the obtained device information.

22. The information processing terminal apparatus as claimed in claim 21,
wherein the device information further includes type information of the connection equipment, and
wherein the controller selects the data transfer antenna based on a type of the connection equipment.

23. The information processing terminal apparatus as claimed in claim 21,
wherein the controller wirelessly receives and obtains the device information via one antenna of the at least one second antenna from the connection equipment.

24. The information processing terminal apparatus as claimed in claim 21, further comprising an image pickup element,
wherein the controller obtains the device information based on an image of the connection equipment taken a picture by the image pickup element.

25. The information processing terminal apparatus as claimed in claim 20,
wherein the controller scales a mark of the connection equipment according to a screen size of the displaying device, and controls the displaying device to display the scaled mark of the connection equipment on the displaying device.

26. The information processing terminal apparatus as claimed in claim 18,
wherein the controller selects the data transfer antenna so that a mark of the connection equipment does not overlap an image displayed on the displaying device.

27. The information processing terminal apparatus as claimed in claim 18,
wherein the controller selects the data transfer antenna so that a mark of the connection equipment is displayed at an edge of the displaying device.

28. The information processing terminal apparatus as claimed in claim 18, further comprising a notice device configured to notify that the first antenna is opposed to the data transfer antenna.

29. The information processing terminal apparatus as claimed in claim 28,
wherein the notice device includes at least one of a visual notice device and an auditory notice device.

30. A connection equipment configured to perform a proximity wireless communication with an information processing terminal apparatus, the connection equipment comprising a first antenna, the information processing terminal apparatus comprising:
a displaying device configured to display predetermined information,
at least one second antenna formed of a transparent conductive film on a front surface of the displaying device, and
a controller configured to select a data transfer antenna from the at least one second antenna, and perform the proximity wireless communication between the first antenna and the data transfer antenna when the first antenna is opposed to the data transfer antenna.

31. The connection equipment as claimed in claim 30,
wherein the connection equipment wirelessly transmits device information including position information of the first antenna at the connection equipment and shape information of the connection equipment to the information processing terminal apparatus.

32. The connection equipment as claimed in claim 31,
wherein the device information further includes type information of the connection equipment.

33. A communication system comprising an information processing terminal apparatus and a connection equipment,
wherein the information processing terminal apparatus is configured to perform a proximity wireless communication with the connection equipment,
wherein the connection equipment is configured to perform a proximity wireless communication with the information processing terminal apparatus,
wherein the connection equipment comprises a first antenna, and
wherein the information processing terminal apparatus comprises
a displaying device configured to display predetermined information,
at least one second antenna formed of a transparent conductive film on a front surface of the displaying device, and
a controller configured to select a data transfer antenna from the at least one second antenna, and perform the proximity wireless communication between the first antenna and the data transfer antenna when the first antenna is opposed to the data transfer antenna.

34. A communication method for a communication system comprising an information processing terminal apparatus and a connection equipment for performing a proximity wireless communication with the information processing terminal apparatus,
wherein the connection equipment comprises a first antenna, and
wherein the information processing terminal apparatus comprises a displaying device configured to display predetermined information and at least one second antenna formed of a transparent conductive film on a front surface of the displaying device,
wherein the communication method includes the step of:
selecting a data transfer antenna from the at least one second antenna, and performing the proximity wireless communication between the first antenna and the data transfer antenna when the first antenna is opposed to the data transfer antenna, by the information processing terminal apparatus.
